(19) United States
(12) Patent Application Publication
(10) Pub. No.: US 2009/0121556 A1
(43) Pub. Date: May 14, 2009

(54) Electric machinery of permeable polar face & magnetic circuit sandwiched PM magnetic pole

(76) Inventor: Tai-Her Yang, Dzan-Hwa (TW)

Correspondence Address: BACON & THOMAS, PLLC, 625 SLATERS LANE, FOURTH FLOOR, ALEXANDRIA, VA, 22314-1176, US

(21) Appl. No.: 11/979,817

(22) Filed: Nov. 9, 2007

(51) Int. Cl. H02K 1/17; H02K 21/26; H02K 41/00

(52) U.S. Cl. 310/12; 310/10; 310/154.02

(57) ABSTRACT

An electric machinery provided with a PM magnetic pole sandwiched by a permeable polar face and a magnetic circuit from an individual magnetic pole provides an innovative design of having disposed the PM magnetic pole sandwiched between the permeable polar face and the magnetic circuit from the individual magnetic pole to prevent PM magnetic pole from falling off and avoid PM magnetic pole magnetic force from being weakened by inverse excitation during the operation.

### BACKGROUND OF THE INVENTION

(a) Field of the Invention

The present invention is related to an electric machinery with a permanent magnetic pole sandwiched by the permeable polar face and magnetic circuit of its individual magnetic pole, and more particularly, to a permanent magnet (PM) magnetic pole sandwiched by a permeable polar face and magnetic circuit of an individual magnetic pole that is disposed in various types of electric machinery of the prior art.

(b) Description of the Prior Art:

Whereas a conventional AC or DC revolution or linear electric machinery either of commutator, brush, brushless, ring-brush, synchronous, asynchronous, internal revolving, external revolving, double-acting, multi-layer, multi-ring, linear, DC brushless, or inverter electric machinery, or an electric machinery functioning as a generator or as a motor, coupling transmission device, as an EME vortex coupling transmission device, or an EME vortex braking device, is usually provided with a magnetic pole structure to produce EM effect operation.

A magnetic pole structure of the prior art is comprised of:
conducted winding exciting magnetic pole having on its polar face disposed with a PM magnetic pole indicate cumulative or differential; or
a magnetic pole structure of DC or AC electrically conducted winding excitation; or
a PM magnetic pole structure.

As illustrated in FIG. 1 of the accompanying drawings for a schematic view showing a structure of a conventional PM magnetic pole, the structure features an advantage of not requiring a magnetic field exciting current but is found with a flaw of having its magnetic power to be weakened by inverse excitation in the course of the operation of an electric machinery.

### SUMMARY OF THE INVENTION

The primary purpose of the present invention is to provide an electric machinery that has its PM magnetic pole sandwiched by a permeable polar face and magnetic circuit of its individual magnetic pole, and more particularly, to a permanent magnet (PM) magnetic pole sandwiched by a permeable polar face and magnetic circuit of an individual magnetic pole that is disposed in various types of electric machinery of the prior art.

The electric machinery may be disposed in a way that polarities of two PM magnetic poles respectively sandwiched by permeable polar face and magnetic circuit of abutted individual magnetic poles are identical with or opposite to each other.

In the electric machinery of PM magnetic pole sandwiched by permeable polar face and magnetic circuit, the PM magnetic pole is prevented from falling off due to shaking or from having its magnetic power weakened by inverse excitation during the operation of the electric machinery due to an innovative design of having a PM magnetic pole sandwiched by a permeable polar face and magnetic circuit 102 from an individual magnetic pole.

### BRIEF DESCRIPTION OF THE DRAWINGS

FIG. 1 is a schematic view showing a structure of a conventional PM magnetic pole.

FIG. 2 is a schematic view showing a structure of the present invention applied in a PM magnetic pole sandwiched by permeable polar face and magnetic circuit from an individual magnetic pole.

FIG. 3 is a schematic view showing a summary profile of a structure of a main unit of the present invention applied in a cylinder electric machinery without casing, bearing, locking member, cooling van, and optional conductive device.

FIG. 4 is a schematic view showing a summary profile of a structure of a main unit of the present invention applied in a coaxial, 3-ring type electric machinery without casing, bearing, locking member, cooling van, and optional conductive device.

FIG. 5 is a schematic view showing a summary profile of a structure of a main unit of the present invention applied in a coaxial, double layer type electric machinery in plate form without casing, bearing, locking member, cooling van, and optional conductive device.

FIG. 6 is a schematic view showing a summary profile of a structure of a main unit of the present invention applied in a coaxial, 3-layer type electric machinery in plate form without casing, bearing, locking member, cooling van, and optional conductive device.

FIG. 7 is a schematic view showing a summary profile of a structure of a main unit of the present invention applied in a linear, double layer type electric machinery without casing, bearing, locking member, cooling van, and optional conductive device.

FIG. 8 is a schematic view showing a summary profile of a structure of a main unit of the present invention applied in a linear, 3-layer type electric machinery without casing, bearing, locking member, cooling van, and optional conductive device.

FIG. 9 is a schematic view showing a structure of the present invention applied in a cylinder electric machinery structure, wherein a PM magnetic pole sandwiched by a permeable polar face and a magnetic circuit from an individual magnetic pole is disposed for an outer layer electric machinery structure to execute EME coupling to an inner layer electric machinery structure.

FIG. 10 is a schematic view showing a structure of the present invention applied in a cylinder electric machinery structure, wherein a PM magnetic pole sandwiched by a permeable polar face and a magnetic circuit from an individual magnetic pole is disposed on an EME coupling aspect of an inner layer electric machinery structure to execute EME coupling with an outer layer electric machinery structure.

FIG. 11 is a schematic view showing a structure of the present invention applied in a coaxial, 3-ring type electric machinery structure, wherein a PM magnetic pole sandwiched by a permeable polar face and a magnetic circuit from an individual magnetic pole is disposed on an EME coupling aspect of an outer ring electric machinery structure to execute EME coupling with an mid ring electric machinery structure in a direction facing the mid ring electric machinery structure.

FIG. 12 is a schematic view showing a structure of the present invention applied in a coaxial, 3-ring type electric machinery structure, wherein two PM magnetic poles with each being sandwiched by a permeable polar face and a magnetic circuit from an individual magnetic pole are respectively disposed on an EME coupling aspect of an outer ring electric machinery structure to execute EME coupling with an mid ring electric machinery structure and on an EME coupling aspect of the mid ring electric machinery structure to execute EME coupling with an inner ring electric machinery structure.

FIG. 13 is a schematic view showing a structure of the present invention applied in a coaxial, 3-ring type electric machinery structure, wherein a PM magnetic pole sandwiched by a permeable polar face and a magnetic circuit from an individual magnetic pole is disposed on an EME coupling aspect of a mid ring electric machinery structure to execute EME coupling with an outer ring electric machinery structure and an inner ring electric machinery structure in a direction facing an inner ring electric machinery structure.

FIG. 14 is a schematic view showing a structure of the present invention applied in a coaxial, 3-ring type electric machinery structure, wherein a PM magnetic pole sandwiched by a permeable polar face and a magnetic circuit from an individual magnetic pole is disposed on an EME coupling aspect of an inner ring electric machinery structure to execute EME coupling with a mid ring electric machinery structure in a direction facing the mid ring electric machinery structure.

FIG. 15 is a schematic view showing a structure of the present invention applied in a coaxial, 3-ring type electric machinery structure, wherein two PM magnetic poles with each being sandwiched by a permeable polar face and a magnetic circuit from an individual magnetic pole are respectively disposed on an. EME coupling aspect of an inner ring electric machinery structure to execute EME coupling with a mid ring electric machinery structure and on an EME coupling aspect of the mid ring electric machinery structure to execute EME coupling with an outer ring electric machinery structure.

FIG. 16 is a schematic view showing a structure of the present invention applied in a coaxial, 3-ring type electric machinery structure, wherein a PM magnetic pole sandwiched by a permeable polar face and a magnetic circuit from an individual magnetic pole is disposed on an EME coupling aspect of mid ring electric machinery structure to execute EME coupling with an outer ring electric machinery structure and an inner ring electric machinery structure in a direction facing the outer ring electric machinery structure.

FIG. 17 is a schematic view showing a structure of the present invention applied in a coaxial, 3-ring type electric machinery structure, wherein two PM magnetic poles with each being sandwiched by a permeable polar face and a magnetic circuit from an individual magnetic pole are respectively disposed on an outer ring electric machinery structure to execute EME coupling with a mid ring electric machinery structure and on an inner ring electric machinery structure to execute EME coupling with a mid ring electric machinery structure.

FIG. 18 is a schematic view showing a structure of the present invention applied in a coaxial, 3-ring type electric machinery structure, wherein two PM magnetic poles each sandwiched by a permeable polar face and a magnetic circuit from an individual magnetic pole are respectively disposed on an EME coupling aspect of a mid ring electric machinery structure to execute EME coupling with an outer ring electric machinery structure and an inner ring electric machinery structure in a direction facing the EME coupling aspect of the outer ring electric machinery and in another direction facing the EME coupling aspect of the inner ring electric machinery structure.

FIG. 19 is a schematic view showing a structure of the present invention applied in a 3-ring type electric machinery structure wherein a PM magnetic pole to execute two-way coupling with an inner ring electric machinery structure and an outer ring electric machinery structure is disposed to a mid ring electric machinery structure to execute EME coupling with the inner ring electric machinery structure and the outer ring electric machinery structure to constitute a magnetic pole; and a permeable magnetic face is each disposed on both polar ends of the PM magnetic pole.

FIG. 20 is a schematic view showing a structure of the present invention applied in a double layer type plate electric machinery structure wherein a PM magnetic pole sandwiched by a permeable magnetic polar face and a magnetic circuit form an individual magnetic pole is disposed on an EME coupling aspect of the inner layer plate electric machinery structure.

FIG. 21 is a schematic view showing a structure of the present invention applied in a coaxial, 3-layer type plate electric machinery structure wherein a PM magnetic pole sandwiched by a permeable magnetic polar face and a magnetic circuit form an individual magnetic pole is disposed on an EME coupling aspect of an inner layer plate electric machinery structure.

FIG. 22 is a schematic view showing a structure of the present invention applied in a coaxial, 3-layer type plate electric machinery structure wherein two PM magnetic poles with each being sandwiched by a permeable magnetic polar face and a magnetic circuit form an individual magnetic pole are respectively disposed on an EME coupling aspect of an inner layer plate electric machinery structure facing a mid layer plate electric machinery structure, and on an EME coupling aspect of the mid layer plate electric machinery structure facing an outer layer plate electric machinery structure.

FIG. 23 is a schematic view showing a structure of the present invention applied in a coaxial, 3-layer type plate electric machinery structure wherein a PM magnetic pole sandwiched by a permeable magnetic polar face and a magnetic circuit from an individual magnetic pole is disposed on an EME coupling aspect facing an inner layer plate electric machinery structure of a mid layer plate electric machinery structure to execute EME coupling with the inner layer plate electric machinery structure and an outer layer plate electric machinery structure disposed on both sides of the present invention.

FIG. 24 is a schematic view showing a structure of the present invention applied in a coaxial, 3-layer type plate electric machinery structure wherein two PM magnetic poles with each being sandwiched by a permeable magnetic polar face and a magnetic circuit from an individual magnetic pole are respectively disposed on an EME coupling aspect of an inner layer plate electric machinery structure, and on an EME coupling aspect of an outer layer plate electric machinery structure to respectively execute EME coupling with a mid layer plate electric machinery structure.

FIG. 25 is a schematic view showing a structure of the present invention applied in a coaxial, 3-layer type plate electric machinery structure wherein two PM magnetic poles each being sandwiched by a permeable magnetic polar face and a magnetic circuit from an individual magnetic pole are respectively disposed on both sides of a mid layer plate electric machinery structure to execute EME coupling with an inner layer plate electric machinery structure and an outer layer plate electric machinery structure disposed on both sides of the present invention.

FIG. 26 is a schematic view showing a structure of the present invention applied in a coaxial, 3-layer type plate electric machinery structure wherein a mid layer plate electric machinery structure to execute EME coupling with an inner layer plate electric machinery structure and an outer layer plate electric machinery structure on both sides of the present invention is disposed with a PM magnetic pole to constitute a magnetic pole and two permeable magnetic faces are each disposed on both polar faces on both ends of the PM magnetic pole.

FIG. 27 is a schematic view showing a structure of the present invention applied in a linear double layer type electric machinery structure wherein the double linear electric machinery has disposed on an EME coupling aspect of an inner layer linear electric machinery structure a PM magnetic pole sandwiched by a permeable magnetic aspect and a magnetic circuit from an individual magnetic pole.

FIG. 28 is a schematic view showing a structure of the present invention applied in a linear 3-layer type electric machinery structure wherein a PM magnetic pole sandwiched by a permeable magnetic aspect and a magnetic circuit from an individual magnetic pole is disposed to an inner layer linear electric machinery structure to execute EME coupling with a mid layer linear electric machinery structure.

FIG. 29 is a schematic view showing a structure of the present invention applied in a linear 3-layer type electric machinery structure wherein two PM magnetic poles each being sandwiched by a permeable magnetic aspect and a magnetic circuit from an individual magnetic pole are respectively disposed on an EME coupling aspect of a mid layer linear electric machinery structure to execute EME coupling with an outer layer linear electric machinery structure, and on an EME coupling aspect of an inner layer linear electric machinery structure to execute EME coupling with the mid layer linear electric machinery structure.

FIG. 30 is a schematic view showing a structure of the present invention applied in a linear 3-layer type electric machinery structure wherein a PM magnetic pole sandwiched by a permeable magnetic aspect and a magnetic circuit from an individual magnetic pole is disposed on an EME coupling aspect of a mid layer linear electric machinery structure to execute EME coupling with an outer layer linear electric machinery structure and an inner layer linear electric machinery structure in a direction facing the inner layer linear electric machinery structure.

FIG. 31 is a schematic view showing a structure of the present invention applied in a linear 3-layer type electric machinery structure wherein two PM magnetic poles each being sandwiched by a permeable magnetic aspect and a magnetic circuit from an individual magnetic pole are respectively disposed on an EME coupling aspect of an outer layer linear electric machinery structure to execute EME coupling with a mid layer linear electric machinery structure, and on an EME coupling aspect of an inner layer linear electric machinery structure to execute EME coupling with the mid layer linear electric machinery structure.

FIG. 32 is a schematic view showing a structure of the present invention applied in a linear 3-layer type electric machinery structure wherein two PM magnetic poles each being sandwiched by a permeable magnetic aspect and a magnetic circuit from an individual magnetic pole are respectively disposed on two EME coupling aspects of both sides of a mid layer linear electric machinery structure to execute EME coupling with an outer layer linear electric machinery structure and an inner layer linear electric machinery structure to execute EME coupling with the mid layer linear electric machinery structure.

FIG. 33 is a schematic view showing a structure of the present invention applied in a linear 3-layer type electric machinery structure wherein a PM magnetic pole is disposed to a mid layer linear electric machinery structure to execute EME coupling with an outer layer linear electric machinery structure and an inner layer linear electric machinery structure, and two permeable polar faces are respectively disposed on both ends of the PM.

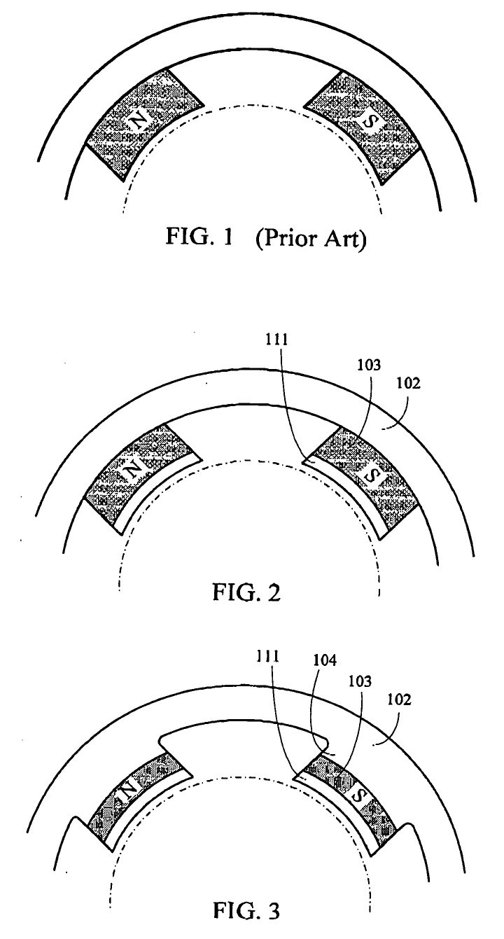

### LISTING OF COMPONENT AND CORRESPONDING LABEL

102: magnetic circuit
103: PM magnetic pole
11: inner layer electric machinery structure of cylinder electric machinery
12: outer layer electric machinery structure of cylinder electric machinery
21: inner ring electric machinery structure of coaxial 3-ring type electric machinery
22: mid ring electric machinery structure of coaxial 3-ring type electric machinery
23: outer ring electric machinery structure of coaxial 3-ring type electric machinery
31: inner layer plate electric machinery structure of coaxial double layer type plate electric machinery
32: outer layer plate electric machinery structure of coaxial double layer type plate electric machinery
41: inner layer plate electric machinery structure of coaxial 3-layer type plate electric machinery
42: mid layer plate electric machinery structure of coaxial 3-layer type plate electric machinery
43: outer layer plate electric machinery structure of coaxial 3-layer type plate electric machinery
51: inner layer linear electric machinery structure of linear double layer type electric machinery
52: outer layer linear electric machinery structure of linear double layer type electric machinery
61: inner layer linear electric machinery structure of linear 3-layer type electric machinery
62: mid layer linear electric machinery structure of linear 3-layer type electric machinery
63: outer layer linear electric machinery structure of linear 3-layer type electric machinery
111: permeable polar face

### DETAILED DESCRIPTION OF THE PREFERRED EMBODIMENTS

The present invention discloses an electric machinery provided with a PM magnetic pole sandwiched by a permeable polar face and a magnetic circuit, which is related to a PM magnetic pole 103 sandwiched by a permeable polar face 111 and a magnetic circuit 102 from an individual magnetic pole disposed in various types of electric machinery of the prior art. As illustrated in FIG. 2 for a schematic view showing a structure of the present invention applied in a PM magnetic pole sandwiched by permeable polar face and magnetic circuit from an individual magnetic pole; the present invention is disposed so that an electric machinery may be disposed in a way that polarities of two PM magnetic poles respectively sandwiched by a permeable polar face and a magnetic circuit of abutted individual magnetic poles are identical with or opposite to each other.

As illustrated in FIG. 2, in the electric machinery provided with the PM magnetic pole sandwiched by the permeable polar face and the magnetic circuit, the permeable polar face 111 to sandwich the PM magnetic pole jointly with the magnetic circuit is comprised of a material of copper, iron, or nickel providing good permeability and made in an integral part or a stack of multiple sheets by lamination; a polar face of the permeable polar face 111 faces a structure of another electric machinery that interacts with the permeable polar face 111 to execute EME; and the permeable polar face 111 indicates a convex, concave, or flat surface, or is further disposed with a groove to indicate protrusion and indention pattern or a specific geometric form depending on the needs.

For example, ways of having the PM magnetic pole 103 sandwiched by the permeable polar face 111 and the magnetic circuit 102 from an individual magnetic pole in the electric machinery provided with a PM magnetic pole sandwiched by the permeable polar face and the magnetic circuit include having a mechanical locking member to clamp or secure, a screw and a nut structure to lock up, a rivet to secure, a pin and a pinhole structure to fix, or a packing means in proper size and selected geometric form to insert, a magnetic circuit structure to clamp, a casing to clamp, a dedicated structural member to clamp, an adhesion to bind the PM magnetic pole 103, or having any other means of the prior art to secure the PM magnetic pole 103.

The electric machinery provided with a PM magnetic pole sandwiched by the permeable polar face and the magnetic circuit may operate with a DC or AC revolution electrical machinery or a linear electric machinery including commutator brush, brushless, ring brush, synchronous, asynchronous, internal revolving, external revolving, double-acting, multi-layer, multi-ring, linear, DC brushless, or inverter electric machinery, or an electric machinery functioning as a generator or as a motor, coupling transmission device, as an EME vortex coupling transmission device, or an EME vortex braking device for functional operation.

In the electric machinery of PM magnetic pole sandwiched by permeable polar face and magnetic circuit, the PM magnetic pole is prevented from falling off due to shaking or from having its magnetic power weakened by inverse excitation during the operation of the electric machinery due to an innovative design of having a PM magnetic pole 103 sandwiched by a permeable polar face 111 and magnetic circuit 102 from an individual magnetic pole.

Types of electric machinery applying the electric machinery provided with a PM magnetic pole sandwiched by the permeable polar face and the magnetic circuit include:

1. A cylinder electric machinery in a construction comprised of an inner layer electric machinery structure and an outer layer electric machinery structure, including an inner layer electric machinery structure 11 and an outer layer electric machinery structure 12 as illustrated in FIG. 3 showing a schematic view of a summary profile of a structure of a main unit of the present invention applied in a cylinder electric machinery without casing, bearing, locking member, cooling van, and optional conductive device;

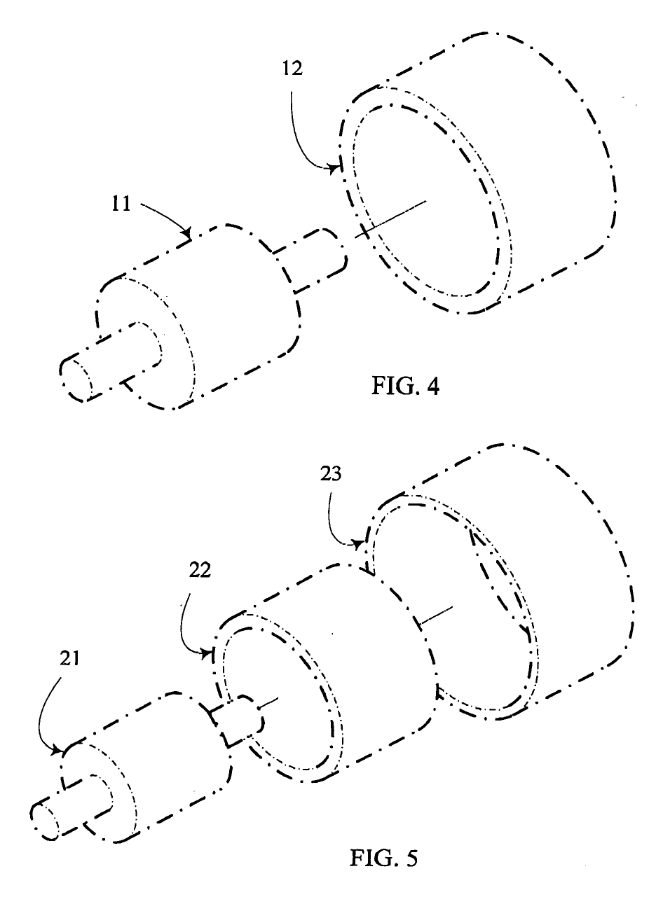

2. A coaxial 3-ring type electric machinery to engage coaxial operation by insertion of an inner ring, a mid ring, and an outer ring electric machinery structures including an inner ring electric machinery structure 21, a mid ring electric machinery structure 22, and an outer ring electric machinery structure 23 as illustrated in FIG. 4 for a schematic view showing a summary profile of a structure of a main unit of the present invention applied in a coaxial, 3-ring type electric machinery without casing, bearing, locking member, cooling van, and optional conductive device;

3. A coaxial double layer type plate electric machinery comprised of two layers of electric machinery structure laminated to engage in coaxial operation includes an inner layer plate electric machinery structure 31 and an outer layer plate electric machinery structure 32 as illustrated in FIG. 5 for a schematic view showing a summary profile of a structure of a main unit of the present invention applied in a coaxial, double layer type electric machinery in plate form without casing, bearing, locking member, cooling van, and optional conductive device;

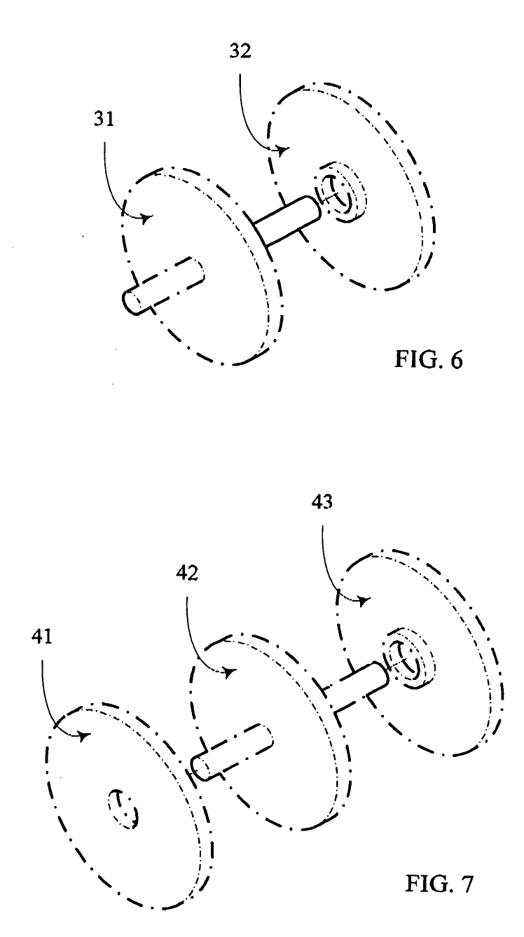

4. A coaxial 3-layer type plate electric machinery comprised of an inner, a mid, and an outer layer electric machinery structures laminated to engage coaxial operation includes an inner layer plate electric machinery structure 41, a mid layer plate electric machinery structure 42, and an outer layer plate electric machinery structure 43 as illustrated in FIG. 6 for a schematic view showing a summary profile of a structure of a main unit of the present invention applied in a coaxial, 3-layer type electric machinery in plate form without casing, bearing, locking member, cooling van, and optional conductive device;

5. A linearly coupled linear double layer type electric machinery comprised of two layers of linear electric machinery structures includes an inner layer linear electric machinery structure 51 and an outer layer linear electric machinery structure 52 as illustrated in FIG. 7 for a schematic view showing a summary profile of a structure of a main unit of the present invention applied in a linear, double layer type electric machinery without casing, bearing, locking member, cooling van, and optional conductive device; and

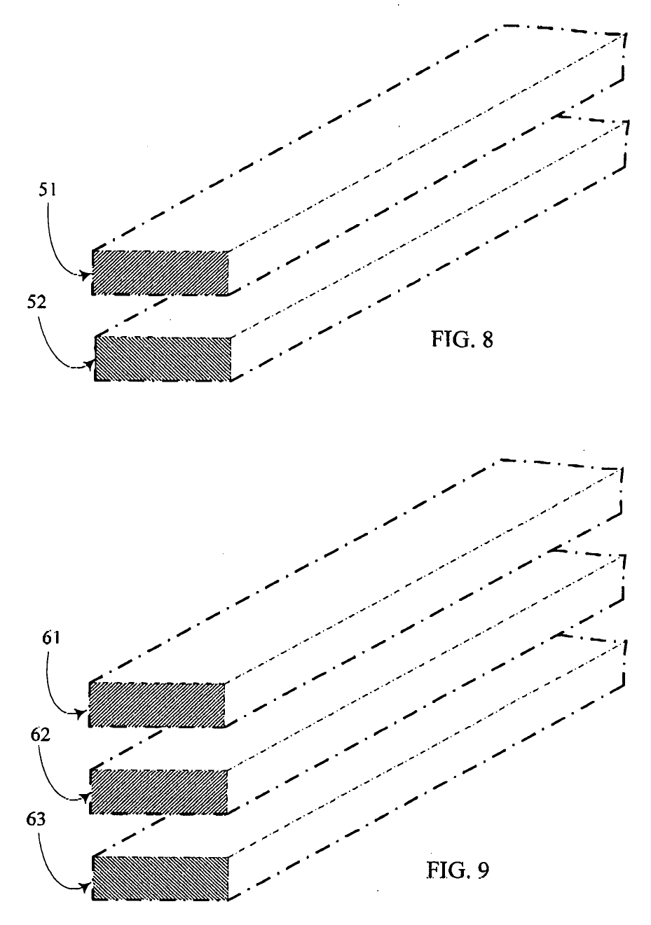

6. A linearly coupled linear 3-layer type electric machinery comprised of a inner layer, a mid layer, and an outer layer linear electric machinery structures includes an inner layer linear electric machinery structure 61, a mid layer linear electric machinery structure 62, and an outer layer linear electric machinery structure 63 as illustrated in FIG. 8 for a schematic view showing a summary profile of a structure of a main unit of the present invention applied in a linear, 3-layer type electric machinery without casing, bearing, locking member, cooling van, and optional conductive device.

For the present invention to be applied in those application examples of various types of structure described below, including two-piece electric machinery structure and 3-piece electric machinery structure, they may be comprised of an electric machinery structure comprised of more elements according to the same operation principle; therefore, it will not be elaborated herein.

Now referring to FIG. 9 for a schematic view showing a structure of the present invention applied in a cylinder electric machinery structure, a PM magnetic pole sandwiched by a permeable polar face and a magnetic circuit from an individual magnetic pole is disposed for an outer layer electric machinery structure to execute EME coupling to an inner layer electric machinery structure.

As illustrated in FIG. 9, in the cylinder electric machinery structure, an outer layer electric machinery structure 12 to execute EME coupling with the inner layer electric machinery structure 11 has provided on its EME coupling aspect the PM magnetic pole 103 sandwiched by the permeable polar face 111 and the magnetic circuit 102 from an individual magnetic pole thus to constitute a cylinder electric machinery provided with the PM magnetic pole sandwiched by the permeable polar face and the magnetic circuit from the individual magnetic pole.

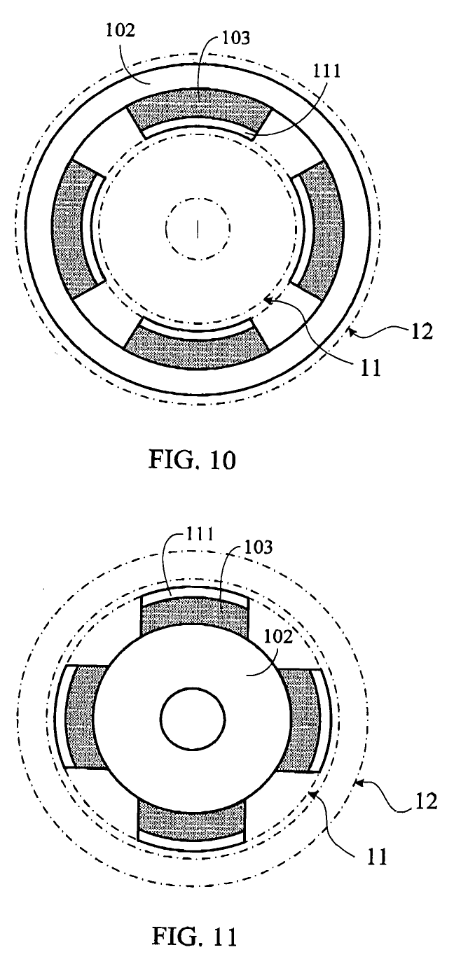

FIG. 10 is a schematic view showing a structure of the present invention applied in a cylinder electric machinery structure, wherein a PM magnetic pole sandwiched by a permeable polar face and a magnetic circuit from an individual magnetic pole is disposed on the EME coupling aspect of an inner layer electric machinery structure to execute EME coupling with an outer layer electric machinery structure.

As illustrated in FIG. 10 for a cylinder electric machinery structure, the inner layer electric machinery structure 11 to execute EME coupling with the outer layer electric machinery structure 12 has provided on its EME coupling aspect the PM magnetic pole 103 sandwiched by the permeable polar face 111 and the magnetic circuit 102 from an individual magnetic pole thus to constitute a cylinder electric machinery provided with the PM magnetic pole sandwiched by the permeable polar face and the magnetic circuit from the individual magnetic pole.

FIG. 11 is a schematic view showing a structure of the present invention applied in a coaxial, 3-ring type electric machinery structure, wherein a PM magnetic pole sandwiched by a permeable polar face and a magnetic circuit from an individual magnetic pole is disposed on an EME coupling aspect of an outer ring electric machinery structure to execute EME coupling with a mid ring electric machinery structure in a direction facing the mid ring electric machinery structure.

As illustrated in FIG. 11, in a coaxial 3-ring type electric machinery structure, the PM magnetic pole 103 sandwiched by a permeable polar face 111 and a magnetic circuit 102 from an individual magnetic pole is disposed on an EME coupling aspect of the outer ring electric machinery structure 23 in facing the mid ring electric machinery structure 22 to execute EME coupling with the mid ring electric machinery structure 22 thus to constitute a coaxial 3-ring type electric machinery provided with the PM magnetic pole sandwiched by the permeable polar face and the magnetic circuit from the individual magnetic pole.

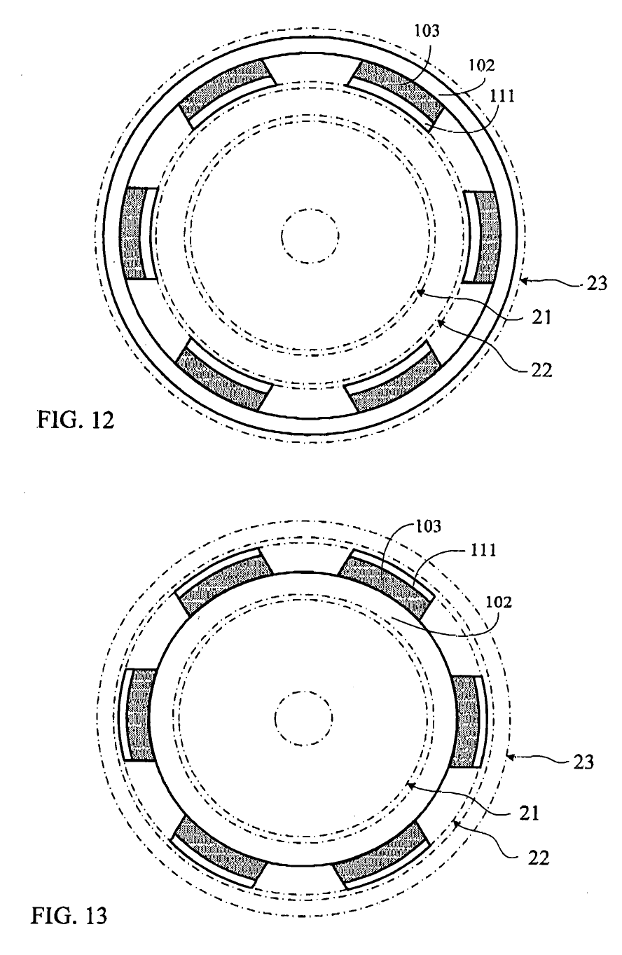

FIG. 12 is a schematic view showing a structure of the present invention applied in a coaxial, 3-ring type electric machinery structure, wherein two PM magnetic poles with each being sandwiched by a permeable polar face and a magnetic circuit from an individual magnetic pole are respectively disposed on an EME coupling aspect of an outer ring electric machinery structure to execute EME coupling with an mid ring electric machinery structure and on an EME coupling aspect of the mid ring electric machinery structure to execute EME coupling with an inner ring electric machinery structure.

As illustrated in FIG. 12 for coaxial 3-ring type electric machinery structure, both of an EME coupling aspect of the outer ring electric machinery structure 23 to execute EMC coupling with the mid ring electric machinery structure 22 and an EME coupling aspect of the mid ring electric machinery structure 22 to execute EME coupling with the inner ring electric machinery structure 21 are respectively provided with the PM magnetic pole 103 sandwiched by a permeable polar face 111 and a magnetic circuit 102 from an individual magnetic pole thus to constitute a coaxial 3-ring type electric machinery provided with two PM magnetic poles each being sandwiched by a permeable polar face and a magnetic circuit from an individual magnetic pole.

FIG. 13 is a schematic view showing a structure of the present invention applied in a coaxial, 3-ring type electric machinery structure, wherein a PM magnetic pole sandwiched by a permeable polar face and a magnetic circuit from an individual magnetic pole is disposed on an EME coupling aspect of a mid ring electric machinery structure to execute EME coupling with an outer ring electric machinery structure and an inner ring electric machinery structure in a direction facing an inner ring electric machinery structure.

As illustrated in FIG. 13 for a coaxial 3-ring type electric machinery structure, the PM magnetic pole 103 sandwiched by a permeable polar face 111 and a magnetic circuit 102 from an individual magnetic pole is disposed on an EME coupling aspect of the mid ring electric machinery structure 22 in a direction facing the inner ring electric machinery structure 21 to execute EME coupling with the outer ring electric machinery structure 23 and the inner ring electric machinery structure 21 thus to constitute a coaxial 3-ring type electric machinery provided with a PM magnetic pole sandwiched by a permeable polar face and a magnetic circuit from an individual magnetic pole.

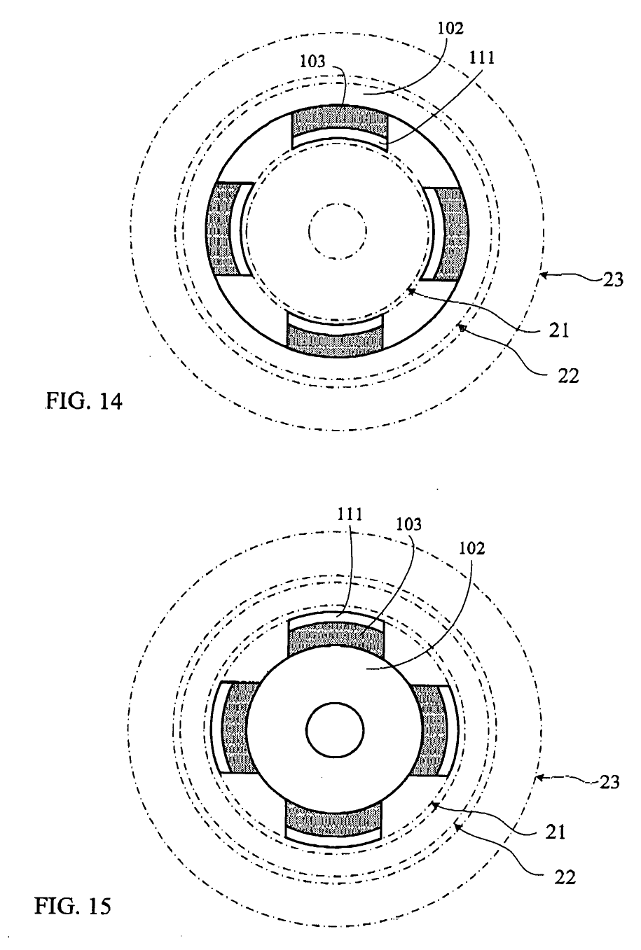

FIG. 14 is a schematic view showing a structure of the present invention applied in a coaxial, 3-ring type electric machinery structure, wherein a PM magnetic pole sandwiched by a permeable polar face and a magnetic circuit from an individual magnetic pole is disposed on an EME coupling aspect of an inner ring electric machinery structure to execute EME coupling with a mid ring electric machinery structure in a direction facing the mid ring electric machinery structure.

As illustrated in FIG. 14 for a coaxial 3-ring type electric machinery structure, the PM magnetic pole 103 sandwiched by the permeable polar face 111 and the magnetic circuit 102 from the individual magnetic pole is disposed on an EME coupling aspect of the inner ring electric machinery structure 21 in a direction facing the mid ring electric machinery structure 22 to execute EME coupling with the mid ring electric machinery structure 22 for both of the mid ring electric machinery structure 22 and the outer ring electric machinery structure 23 to interact with each other in executing EME so to jointly constitute a coaxial 3-ring type electric machinery provided with the PM magnetic pole sandwiched by the permeable polar face and the magnetic circuit from the individual magnetic pole.

FIG. 15 is a schematic view showing a structure of the present invention applied in a coaxial, 3-ring type electric machinery structure, wherein two PM magnetic poles with each being sandwiched by a permeable polar face and a magnetic circuit from an individual magnetic pole are respectively disposed on an EME coupling aspect of an inner ring electric machinery structure to execute EME coupling with a mid ring electric machinery structure and on an EME coupling aspect of the mid ring electric machinery structure to execute EME coupling with an outer ring electric machinery structure.

As illustrated in FIG. 15 for a coaxial 3-ring type electric machinery structure, both of an EME coupling aspect of the inner ring electric machinery structure 21 to execute EME coupling with the mid ring electric machinery structure 22 and an EME coupling aspect of the mid ring electric machinery structure 22 to execute EME coupling with the outer ring electric machinery structure 23 are respectively provided with the PM magnetic pole 103 sandwiched by the permeable polar face 111 and the magnetic circuit 102 from the individual magnetic pole for achieving EME interaction with the outer ring electric machinery structure 23 to jointly constitute a coaxial 3-ring type electric machinery provided with the PM magnetic pole sandwiched by the permeable polar face and the magnetic circuit from the individual magnetic pole.

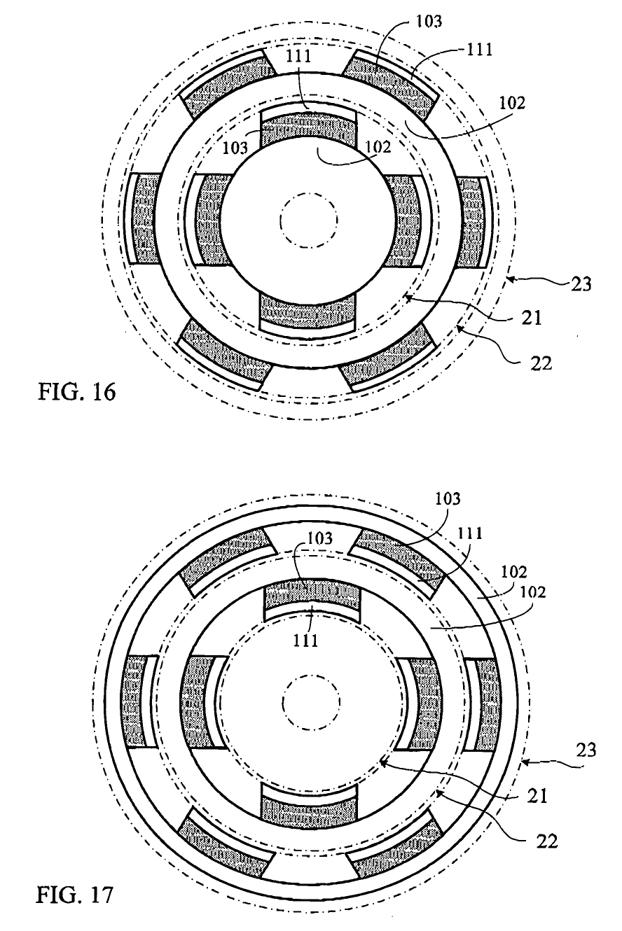

FIG. 16 is a schematic view showing a structure of the present invention applied in a coaxial, 3-ring type electric machinery structure, wherein a PM magnetic pole sandwiched by a permeable polar face and a magnetic circuit from an individual magnetic pole is disposed on an EME coupling aspect of mid ring electric machinery structure to execute EME coupling with an outer ring electric machinery structure and an inner ring electric machinery structure in a direction facing the outer ring electric machinery structure.

As illustrated in FIG. 16 for a coaxial 3-ring type electric machinery structure, the PM magnetic pole 103 sandwiched by the permeable polar face 111 and the magnetic circuit 102 from the individual magnetic pole is provided on an EME coupling aspect of the mid ring electric machinery structure 22 in a direction facing the outer ring electric machinery structure 23 to execute EME coupling with the outer ring electric machinery structure 23 and the inner ring electric machinery structure 21 for the inner ring electric machinery structure 21 and the outer ring electric machinery structure 23 to execute EME interaction to jointly constitute a coaxial 3-ring type electric machinery provided with the PM magnetic pole sandwiched by the permeable polar face and the magnetic circuit from the individual magnetic pole.

FIG. 17 is a schematic view showing a structure of the present invention applied in a coaxial, 3-ring type electric machinery structure, wherein two PM magnetic poles with each being sandwiched by a permeable polar face and a magnetic circuit from an individual magnetic pole are respectively disposed on an outer ring electric machinery structure to execute EME coupling with a mid ring electric machinery structure and on an inner ring electric machinery structure to execute EME coupling with a mid ring electric machinery structure.

As illustrated in FIG. 17 for a coaxial 3-ring type electric machinery structure, both of the outer ring electric machinery structure 23 to execute EME coupling with the mid ring electric machinery structure 22 and the inner ring electric machinery structure 21 to execute EME coupling with the mid ring electric machinery structure 22 are respectively disposed with the PM magnetic pole 103 sandwiched by the permeable polar face 111 and the magnetic circuit 102 from the individual magnetic pole for jointly constituting with the mid ring electric machinery structure 22 a coaxial 3-ring type electric machinery provided with the PM magnetic pole sandwiched by the permeable polar face and the magnetic circuit from the individual magnetic pole.

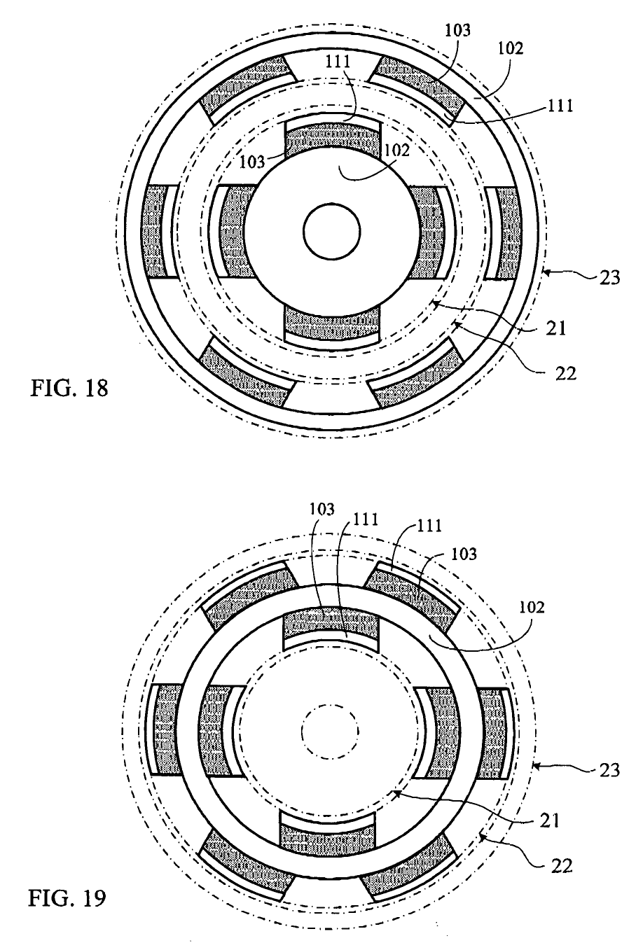

FIG. 18 is a schematic view showing a structure of the present invention applied in a coaxial, 3-ring type electric machinery structure, wherein two PM magnetic poles each sandwiched by a permeable polar face and a magnetic circuit from an individual magnetic pole are respectively disposed on an EME coupling aspect of a mid ring electric machinery structure to execute EME coupling with an outer ring electric machinery structure and an inner ring electric machinery structure in a direction facing the EME coupling aspect of the outer ring electric machinery and in another direction facing the EME coupling aspect of the inner ring electric machinery structure.

As illustrated in FIG. 18 for a coaxial 3-ring type electric machinery structure, two PM magnetic poles 103 each being sandwiched by the permeable polar face 111 and the magnetic circuit 102 from the individual magnetic pole are respectively disposed on two EME coupling aspects of the inner ring electric machinery structure 22 in both directions respectively facing the outer ring electric machinery structure 23 and the inner ring electric machinery structure 21 for both of the inner electric machinery structure 21 and the outer ring electric machinery structure 23 to execute EME interaction for jointly constituting a coaxial 3-ring type electric machinery provided with the PM magnetic pole sandwiched by the permeable polar face and the magnetic circuit from the individual magnetic pole.

FIG. 19 is a schematic view showing a structure of the present invention applied in a 3-ring type electric machinery structure wherein a PM magnetic pole to execute two-way coupling with an inner ring electric machinery structure and an outer ring electric machinery structure is disposed to a mid ring electric machinery structure to execute EME coupling with the inner ring electric machinery structure and the outer ring electric machinery structure to constitute a magnetic pole; and a permeable magnetic face is each disposed on both polar ends of the PM magnetic pole.

As illustrated in FIG. 19 for a coaxial 3-ring type electric machinery structure, the PM magnetic pole 103 to execute two-way coupling with the inner ring electric machinery structure 21 and the outer ring electric machinery structure 23 is provided to the mid ring electric machinery structure 22 to execute EME coupling with the inner ring electric machinery structure 21 and the outer ring electric machinery structure 23 to constitute a magnetic pole; and both polar faces on both ends of the PM magnetic pole 103 are each disposed with a permeable polar face 111 thus to constitute a coaxial 3-ring type electric machinery respectively provided at both ends of the PM magnetic pole the permeable polar face.

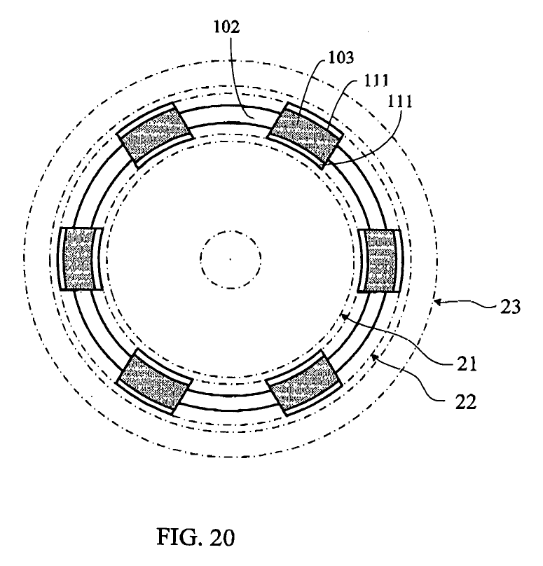

FIG. 20 is a schematic view showing a structure of the present invention applied in a double layer type plate electric machinery structure wherein a PM magnetic pole sandwiched by a permeable magnetic polar face and a magnetic circuit form an individual magnetic pole is disposed on an EME coupling aspect of the inner layer plate electric machinery structure.

As illustrated in FIG. 20 for a double layer type plate electric machinery structure, the PM magnetic pole 103 sandwiched by the permeable polar face 111 and the magnetic circuit 102 from the individual magnetic pole is disposed on an EME coupling aspect of the inner layer plate electric machinery structure 31 to execute EME coupling interaction with the outer layer plate electric machinery structure 32 for jointly constituting a double layer type plate electric machinery provided with the PM magnetic pole sandwiched by the permeable polar face and the magnetic circuit from the individual magnetic pole.

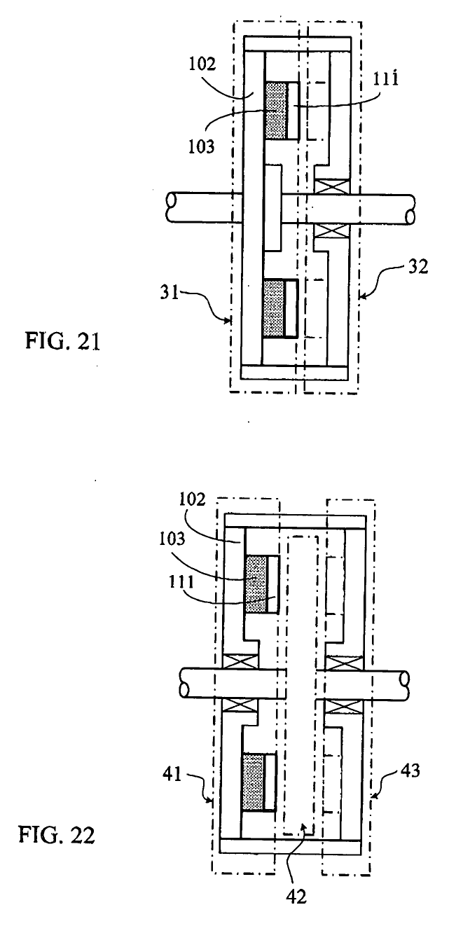

FIG. 21 is a schematic view showing a structure of the present invention applied in a coaxial, 3-layer type plate electric machinery structure wherein a PM magnetic pole sandwiched by a permeable magnetic polar face and a magnetic circuit form an individual magnetic pole is disposed on an EME coupling aspect of an inner layer plate electric machinery structure.

As illustrated in FIG. 21 for a coaxial 3-layer type plate electric machinery structure, the PM magnetic pole 103 sandwiched by the permeable polar face 111 and the magnetic circuit 102 from the individual magnetic pole disposed on an EME coupling aspect of an inner layer plate electric machinery structure 41 for both of the mid layer plate electric machinery structure 42 and the outer layer plate electric machinery structure 43 to execute EME interaction for jointly constituting a 3-layer type plate electric machinery provided with the PM magnetic pole sandwiched by the permeable polar face and the magnetic circuit from the individual magnetic pole.

FIG. 22 is a schematic view showing a structure of the present invention applied in a coaxial, 3-layer type plate electric machinery structure wherein two PM magnetic poles with each being sandwiched by a permeable magnetic polar face and a magnetic circuit from an individual magnetic pole are respectively disposed on an EME coupling aspect of an inner layer plate electric machinery structure facing a mid layer plate electric machinery structure, and on an EME coupling aspect of the mid layer plate electric machinery structure facing an outer layer plate electric machinery structure.

As illustrated in FIG. 22 for a coaxial 3-layer type plate electric machinery structure, both of an EME coupling aspect of the inner layer plate electric machinery structure 41 in facing the mid layer plate electric machinery structure 42, and an EME coupling aspect of the mid layer plate electric machinery structure 42 in facing the outer layer plate electric machinery structure 43 are respectively disposed with the PM magnetic pole 103 sandwiched by the permeable polar face 111 and the magnetic circuit 102 from the individual magnetic pole for jointly constituting with the outer layer plate electric machinery structure 43 a 3-layer type plate electric machinery provided with the PM magnetic pole sandwiched by the permeable polar face and the magnetic circuit from the individual magnetic pole.

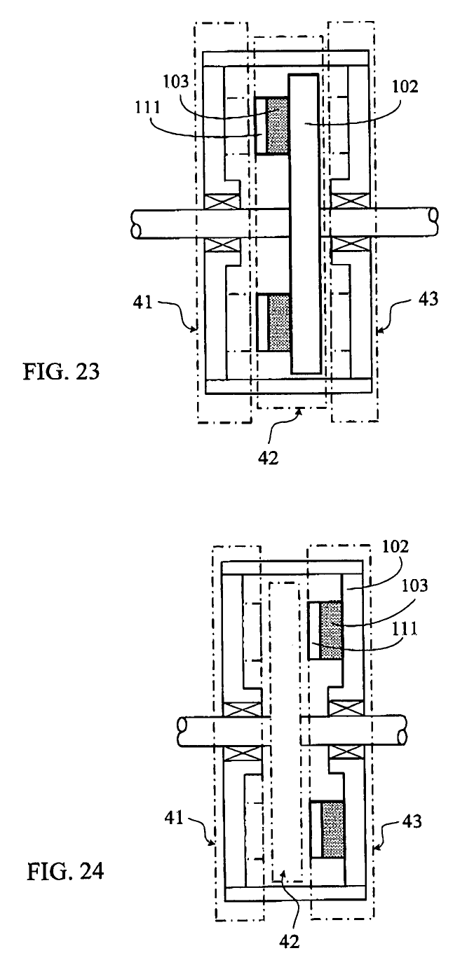

FIG. 23 is a schematic view showing a structure of the present invention applied in a coaxial, 3-layer type plate electric machinery structure wherein a PM magnetic pole sandwiched by a permeable magnetic polar face and a magnetic circuit from an individual magnetic pole is disposed on an EME coupling aspect facing an inner layer plate electric machinery structure of a mid layer plate electric machinery structure to execute EME coupling with the inner layer plate electric machinery structure and an outer layer plate electric machinery structure disposed on both sides of the present invention.

As illustrated in FIG. 23 for a coaxial 3-layer type plate electric machinery structure, the PM magnetic pole 103 sandwiched by the permeable polar face 111 and the magnetic circuit 102 from the individual magnetic pole is disposed to the mid layer plate electric machinery structure 42 to execute EME coupling with the inner layer plate electric machinery structure 41 and the outer layer plate electric machinery structure 43 disposed on both sides of the mid layer plate electric machinery structure 42 in a direction facing the inner layer plate electric machinery structure 41 to execute EME interaction with the inner layer plate electric machinery structure 41 and the outer layer plate electric machinery structure 43, thus to jointly constitute a 3-layer type plate electric machinery provided with the PM magnetic pole sandwiched by the permeable polar face and the magnetic circuit from the individual magnetic pole.

FIG. 24 is a schematic view showing a structure of the present invention applied in a coaxial, 3-layer type plate electric machinery structure wherein two PM magnetic poles with each being sandwiched by a permeable magnetic polar face and a magnetic circuit from an individual magnetic pole are respectively disposed on an EME coupling aspect of an inner layer plate electric machinery structure, and on an EME coupling aspect of an outer layer plate electric machinery structure to respectively execute EME coupling with a mid layer plate electric machinery structure.

As illustrated in FIG. 24 for a coaxial 3-layer type plate electric machinery structure, both of an EME coupling aspect of the inner layer plate electric machinery structure 41 and an EME coupling aspect of the outer layer plate electric machinery structure 43 respectively to execute EME coupling with the mid layer plate electric machinery structure 42 are each disposed with the PM magnetic pole 103 sandwiched by the permeable polar face 111 and the magnetic circuit 102 from the individual magnetic pole to execute EME interaction with the mid layer electric machinery structure 42 thus to jointly constitute a 3-layer type plate electric machinery provided with the PM magnetic pole sandwiched by the permeable polar face and the magnetic circuit from the individual magnetic pole.

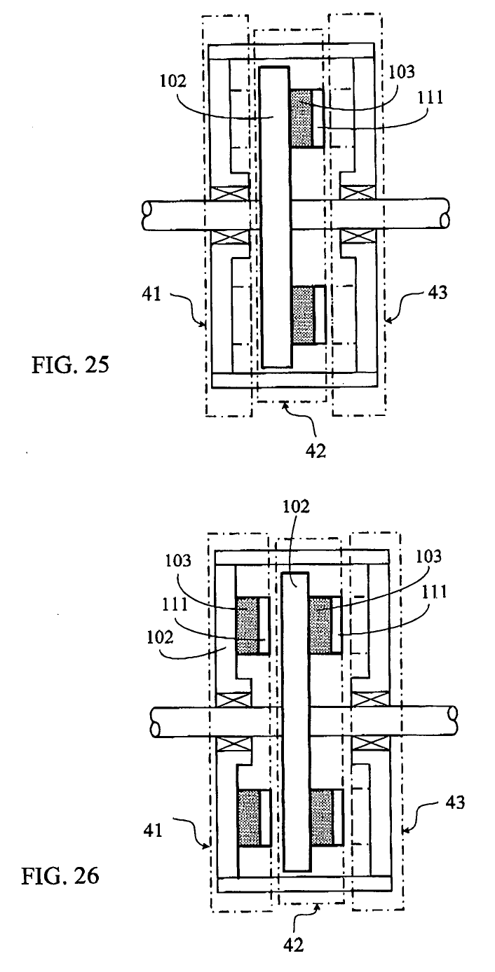

FIG. 25 is a schematic view showing a structure of the present invention applied in a coaxial, 3-layer type plate electric machinery structure wherein two PM magnetic poles each being sandwiched by a permeable magnetic polar face and a magnetic circuit from an individual magnetic pole are respectively disposed on both sides of a mid layer plate electric machinery structure to execute EME coupling with an inner layer plate electric machinery structure and an outer layer plate electric machinery structure disposed on both sides of the present invention.

As illustrated in FIG. 25 for a coaxial 3-layer type plate electric machinery structure, two EME coupling aspects on both sides of the mid layer plate electric machinery structure 42 to execute EME coupling with an inner layer plate electric machinery structure 41 and the outer layer plate electric machinery structure 43 provided on both sides of the mid layer plate electric machinery structure 42 are respectively disposed with the PM magnetic pole 103 sandwiched by the permeable polar face 111 and the magnetic circuit 102 from the individual magnetic pole for executing EME interaction with the inner layer plate electric machinery structure 41 and the outer layer plate electric machinery structure 43 thus to jointly constitute a 3-layer type plate electric machinery provided with the PM magnetic pole sandwiched by the permeable polar face and the magnetic circuit from the individual magnetic pole.

FIG. 26 is a schematic view showing a structure of the present invention applied in a coaxial, 3-layer type plate electric machinery structure wherein a mid layer plate electric machinery structure to execute EME coupling with an inner layer plate electric machinery structure and an outer layer plate electric machinery structure on both sides of the present invention is disposed with a PM magnetic pole to constitute a magnetic pole and two permeable magnetic faces are each disposed on both polar faces on both ends of the PM magnetic pole.

As illustrated in FIG. 26 for a coaxial 3-layer type plate electric machinery structure, the PM magnetic pole 103 is disposed to the mid layer plate electric machinery structure 42 to execute EME coupling with the inner layer plate electric machinery structure 41 and the outer layer plate electric machinery structure 43 provided on both sides of the mid layer plate electric machinery structure 42 to constitute magnetic pole; two permeable polar faces 111 are each disposed on both polar faces at both ends of the PM magnetic pole 103 to execute EME interaction with the inner layer plate electric machinery structure 41 and the outer layer plate electric machinery structure 43 for jointly constituting a coaxial 3-layer type plate electric machinery provided with two permeable polar faces on each of two polar faces disposed on both ends of the PM magnetic pole.

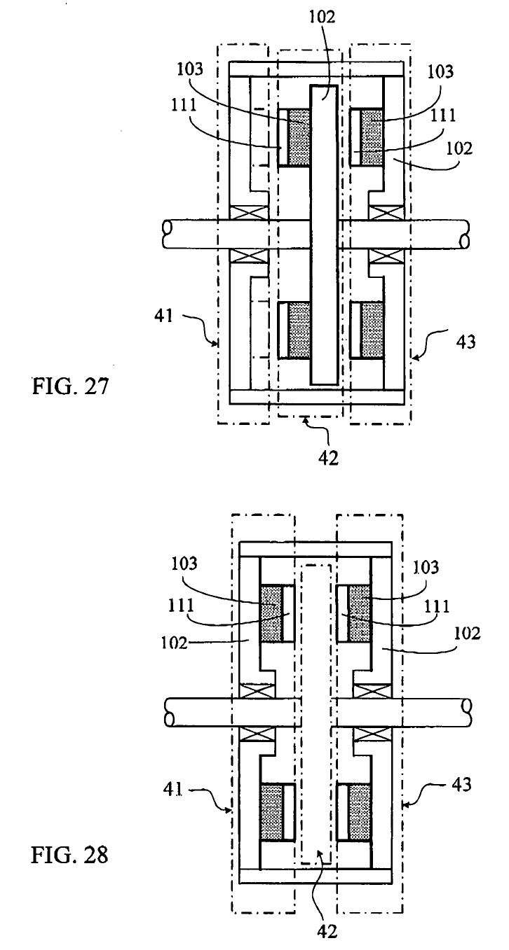

FIG. 27 is a schematic view showing a structure of the present invention applied in a linear double layer type electric machinery structure wherein the double linear electric machinery has disposed on an EME coupling aspect of an inner layer linear electric machinery structure a PM magnetic pole sandwiched by a permeable magnetic aspect and a magnetic circuit from an individual magnetic pole.

As illustrated in FIG. 27 for a linear double layer type electric machinery structure, the PM magnetic pole 103 sandwiched by the permeable polar face 111 and the magnetic circuit 102 from the individual magnetic pole is disposed on an EME coupling aspect of the inner layer linear electric machinery structure 51 to execute EME interaction with the outer layer linear electric machinery structure 52 thus to jointly constitute a double layer type electric machinery provided with the PM magnetic pole sandwiched by the permeable polar face and the magnetic circuit from the individual magnetic pole.

FIG. 28 is a schematic view showing a structure of the present invention applied in a linear 3-layer type electric machinery structure wherein a PM magnetic pole sandwiched by a permeable magnetic aspect and a magnetic circuit from an individual magnetic pole is disposed to an inner layer linear electric machinery structure to execute EME coupling with a mid layer linear electric machinery structure.

As illustrated in FIG. 28 for a linear 3-layer type electric machinery structure, the PM magnetic pole 103 sandwiched by the permeable polar face 111 and the magnetic circuit 102 from the individual magnetic pole is disposed to the inner layer linear electric machinery structure 61 to execute EME coupling with the mid layer linear electric machinery structure 62 for executing EME interaction with the inner layer linear electric machinery structure 61 and the outer layer linear electric machinery structure 63 thus to jointly constitute a linear 3-layer type electric machinery provided with the PM magnetic pole sandwiched by the permeable polar face and the magnetic circuit from the individual magnetic pole.

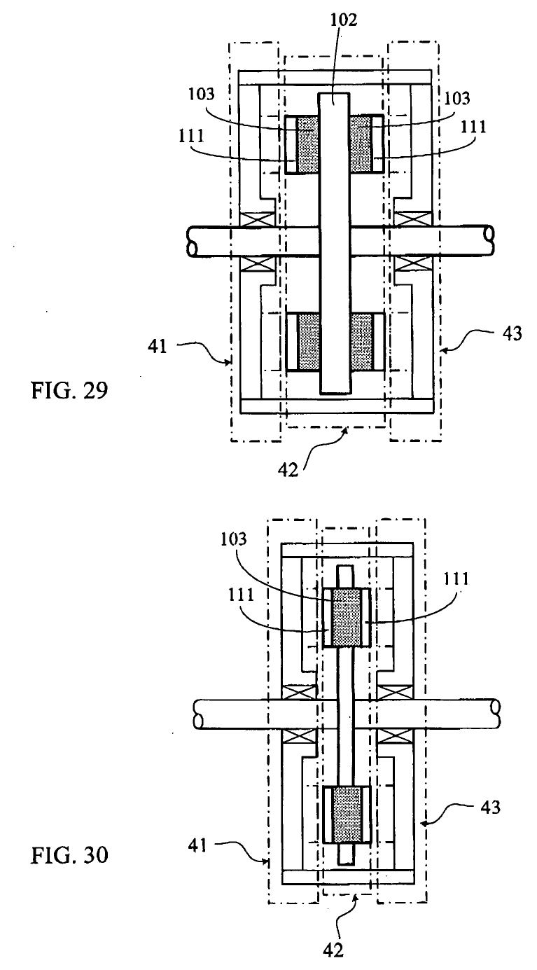

FIG. 29 is a schematic view showing a structure of the present invention applied in a linear 3-layer type electric machinery structure wherein two PM magnetic poles each being sandwiched by a permeable magnetic aspect and a magnetic circuit from an individual magnetic pole are respectively disposed on an EME coupling aspect of a mid layer linear electric machinery structure to execute EME coupling with an outer layer linear electric machinery structure, and on an EME coupling aspect of an inner layer linear electric machinery structure to execute EME coupling with the mid layer linear electric machinery structure.

As illustrated in FIG. 29 for a linear 3-layer type electric machinery structure, both of an EME coupling aspect of the mid layer linear electric machinery structure 62 to execute EME coupling with the outer layer linear electric machinery structure 63 and an EME coupling aspect of the inner layer linear electric machinery structure 61 to execute EME coupling with the mid layer linear electric machinery structure 62 are respectively disposed with the PM magnetic pole 103 sandwiched by the permeable polar face 111 and the magnetic circuit 102 from the individual magnetic pole for executing EME interaction with the outer layer linear electric machinery structure 63, thus to jointly constitute a linear 3-layer type electric machinery provided with the PM magnetic pole sandwiched by the permeable polar face and the magnetic circuit from the individual magnetic pole.

FIG. 30 is a schematic view showing a structure of the present invention applied in a linear 3-layer type electric machinery structure wherein a PM magnetic pole sandwiched by a permeable magnetic aspect and a magnetic circuit from an individual magnetic pole is disposed on an EME coupling aspect of a mid layer linear electric machinery structure to execute EME coupling with an outer layer linear electric machinery structure and an inner layer linear electric machinery structure in a direction facing the inner layer linear electric machinery structure.

As illustrated in FIG. 30 for a linear 3-layer type electric machinery structure, the PM magnetic pole 103 sandwiched by the permeable polar face 111 and the magnetic circuit 102 from the individual magnetic pole is disposed to the mid layer linear electric machinery structure 62 in a direction facing the inner layer linear electric machinery structure 61 for executing EME coupling with the outer layer linear electric machinery structure 63 and the inner layer linear electric machinery structure 61 so to execute EME interaction with the inner layer linear electric machinery structure 61 and the outer layer linear electric machinery structure 63, thus to jointly constitute a linear 3-layer type electric machinery provided with the PM magnetic pole sandwiched by the permeable polar face and the magnetic circuit from the individual magnetic pole.

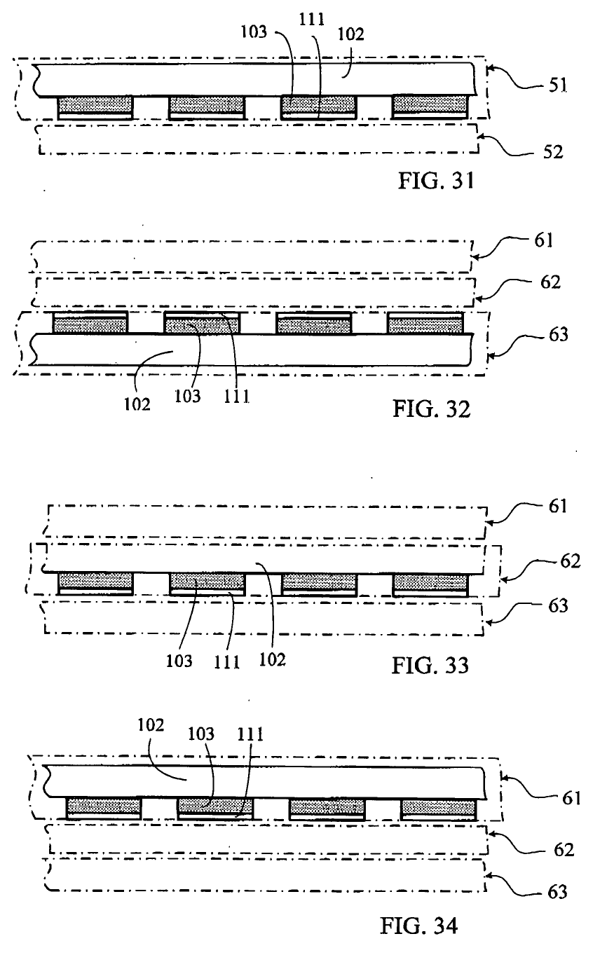

FIG. 31 is a schematic view showing a structure of the present invention applied in a linear 3-layer type electric machinery structure wherein two PM magnetic poles each being sandwiched by a permeable magnetic aspect and a magnetic circuit from an individual magnetic pole are respectively disposed on an EME coupling aspect of an outer layer linear electric machinery structure to execute EME coupling with a mid layer linear electric machinery structure, and on an EME coupling aspect of an inner layer linear electric machinery structure to execute EME coupling with the mid layer linear electric machinery structure.

As illustrated in FIG. 31 for a linear 3-layer type electric machinery structure, an EME coupling aspect of the outer layer linear electric machinery structure 63 to execute EME coupling with the mid layer linear electric machinery structure 62, and an EME coupling aspect of the inner layer linear electric machinery structure 61 are respectively disposed with the PM magnetic pole 103 sandwiched by the permeable polar face 111 and the magnetic circuit 102 from the individual magnetic pole for executing EME interaction with the mid layer linear electric machinery structure 62, thus to joint constitute a linear 3-layer type electric machinery provided with the PM magnetic pole sandwiched by the permeable polar face and the magnetic circuit from the individual magnetic pole.

FIG. 32 is a schematic view showing a structure of the present invention applied in a linear 3-layer type electric machinery structure wherein two PM magnetic poles each being sandwiched by a permeable magnetic aspect and a magnetic circuit from an individual magnetic pole are respectively disposed on two EME coupling aspects of both sides of a mid layer linear electric machinery structure to execute EME coupling with an outer layer linear electric machinery structure and an inner layer linear electric machinery structure to execute EME coupling with the mid layer linear electric machinery structure.

As illustrated in FIG. 32 for a linear 3-layer type electric machinery structure, two PM magnetic poles 103 each being sandwiched by the permeable polar face 111 and the magnetic circuit 102 from the individual magnetic pole are respectively disposed on two EME coupling aspects disposed to both sides of the mid layer linear electric machinery structure 62 to execute EME coupling with the outer layer linear electric machinery structure 63 and the inner layer linear electric machinery structure 61 for executing EME interaction with the inner layer linear electric machinery structure 61 and the outer layer linear electric machinery structure 63 thus to jointly constitute a linear 3-layer type electric machinery provided with the PM magnetic pole sandwiched by the permeable polar face and the magnetic circuit from the individual magnetic pole.

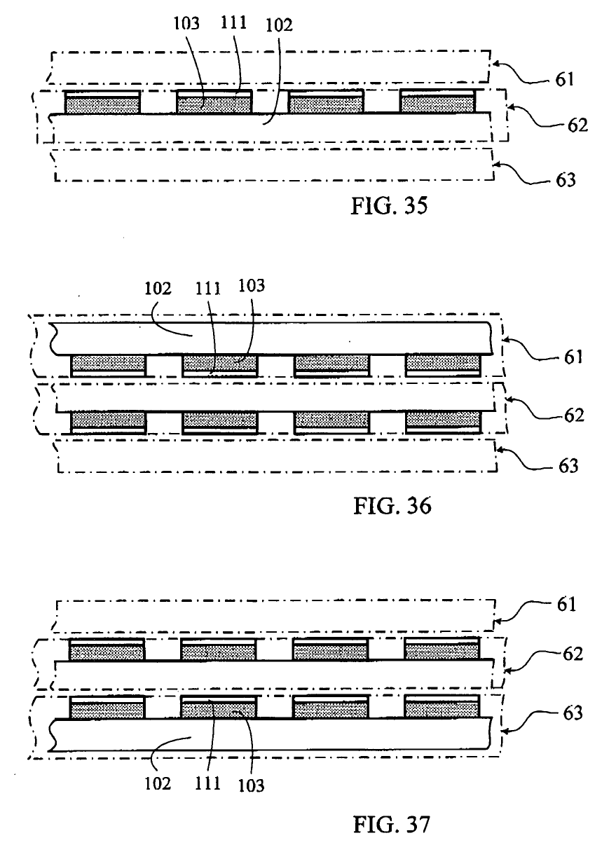

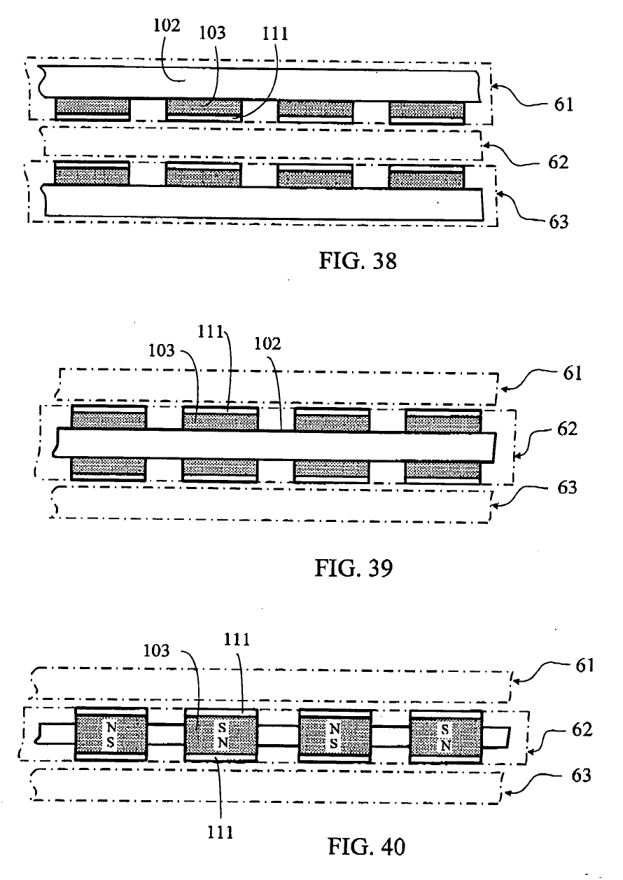

FIG. 33 is a schematic view showing a structure of the present invention applied in a linear 3-layer type electric machinery structure wherein a PM magnetic pole is disposed to a mid layer linear electric machinery structure to execute EME coupling with an outer layer linear electric machinery structure and an inner layer linear electric machinery structure, and two permeable polar faces are respectively disposed on both ends of the PM.

As illustrated in FIG. 33 for a linear 3-layer type electric machinery structure, a PM magnetic pole 103 is disposed to the mid layer linear electric machinery structure 62 to constitute a magnetic pole for executing EME coupling with the outer layer linear electric machinery structure 63 and the inner layer linear electric machinery structure 61; and a permeable polar face 111 is each disposed on both polar faces at both ends of the PM magnetic pole 103 for executing EME interaction with the inner layer linear electric machinery structure 61 and the outer layer linear electric machinery structure 63, thus to jointly constitute a linear 3-layer type electric machinery provided with two permeable solar faces each disposed on two polar faces on both ends of the PM magnetic pole 103.

Quantity of the magnetic pole disposed on the EME coupling aspect of each electric machinery structure for all those preferred embodiments described in FIGS. 2 through 33 may selected to be the same or different as applicable.

In practical application, operation types of two electric machinery components interacting with each other by means of EME of the electric machinery disposed with a PM magnetic pole sandwiched by a permeable polar face and a magnetic circuit in case of the cylinder electric machinery (as illustrated in FIGS. 9 and 10) or the double layer type plate electric machinery (as illustrated in FIG. 20), or the double layer type linear electric machinery (as illustrated in FIG. 27) for producing function of a generator, a motor, an EME vortex coupling transmission, or EME vortex braking function include:

1. Either electric machinery structural component serves as a static portion while another electric machinery structural component serves as a mobile portion; or

2. Both electric machinery structural components function as the mobile portions.

In practical application, the electric machinery provided with a PM magnetic pole sandwiched by a permeable polar face and a magnetic circuit from an individual magnetic pole, e.g., the coaxial 3-ring type electric machinery (as illustrated in FIGS. 11 through 19), the coaxial 3-layer type plate electric machinery (as illustrated in FIGS. 21 through 26), or the linear 3-layer type electric machinery (as illustrated in FIGS. 28 through 33), those three interacting electric machinery structural components for producing function of a generator, a motor, an EME vortex coupling transmission, or EME vortex braking function provide the following composition functions:

1. One EM structural component serves as a static portion while the other two EM structural components function as two mobile portions; or

2. Two EM structural components serve as two static portions while the third EM structural component serves as a mobile portion; or

3. All three EM structural components each serves as a mobile portion.

In the electric machinery provided with a PM magnetic pole sandwiched by a permeable polar face and a magnetic circuit from an individual magnetic pole as described in those preferred embodiments illustrated in FIGS. 2 through 33, selection and layout of electric machinery structure and windings for the electric machinery structural component of the PM magnetic pole sandwiched by the permeable polar face and a magnetic circuit from the individual magnetic pole and other electric machinery structural components executing EME coupling interaction are determined according to the property of the assembly of the entire electric machinery, nature of the power inputted, control function, control mode, and output performance requirements.

The properties of the assembly of the electric machinery provided with a PM magnetic pole sandwiched by a permeable polar face and a magnetic circuit including those for operating in DC or AC revolution or linear electric machinery are comprised of commutator brush, brushless, ring-brush, synchronous, asynchronous, internal revolving, external revolving, double-acting, multi-layer, multi-ring, linear, DC brushless, or inverter electric machinery, or an electric machinery functioning as a generator or as a motor, coupling transmission device, as an EME vortex coupling transmission device, or an EME vortex braking device.

Accordingly, the electric machinery provided with a PM magnetic pole sandwiched by a permeable polar face and a magnetic circuit from an individual magnetic pole of the present invention by having disposed the PM magnetic pole sandwiched between the permeable polar face and the magnetic circuit from the individual magnetic pole is characterized in that it prevents PM magnetic pole from falling off and avoids its magnetic force of the PM magnetic pole from being weakened by inverse excitation during the operation when compared to the conventional electric machinery having adhered a PM magnetic pole to a polar face.

1. An electric machinery provided with a PM magnetic pole sandwiched by a permeable polar face and a magnetic circuit, related to a PM magnetic pole sandwiched by permeable polar face and magnetic circuit from an individual magnetic pole; and arranged in that that polarities of two PM magnetic poles 103 each being sandwiched by a permeable polar face 111 and a magnetic circuit 102 of abutted individual magnetic poles are identical with or opposite to each other.

2. The electric machinery provided with a PM magnetic pole sandwiched by a permeable polar face and a magnetic circuit as claimed in claim 1, wherein the permeable polar face 111 to sandwich the PM magnetic pole 103, jointly with the magnetic circuit 102 is comprised of a material of copper, iron, or nickel providing good permeability and made in an integral part or a stack of multiple sheets by lamination; a polar face of the permeable polar face 111 faces a structure of another electric machinery that interacts with the permeable polar face 111 to execute EME; and the permeable polar face 111 indicates a convex, concave or flat surface or is further disposed with a groove to indicate protrusion and indention pattern or a specific geometric form as applicable.

3. The electric machinery provided with a PM magnetic pole sandwiched by a permeable polar face and a magnetic circuit as claimed in claim 1, wherein ways of having the PM magnetic pole 103 by the permeable polar face 111 and the magnetic circuit 102 from an individual magnetic pole in the electric machinery include having a mechanical locking member to clamp or secure, a screw and a nut structure to lock up, a rivet to secure, a pin and a pinhole structure to fix, or a packing means in proper size and selected geometric form to insert, a magnetic circuit structure to clamp, a casing to clamp, a dedicated structural member to clamp, an adhesion to bind the PM magnetic polar 103, or having any other means of the prior art to secure the PM magnetic pole 103.

4. The electric machinery provided with a PM magnetic pole sandwiched by a permeable polar face and a magnetic circuit as claimed in claim 1, wherein the electric machinery is related to a cylinder electric machinery in a construction comprised of an inner layer electric machinery structure and an outer layer electric machinery, including an inner layer electric machinery structure 11 and an outer layer electric machinery structure 12.

5. The electric machinery provided with a PM magnetic pole sandwiched by a permeable polar face and a magnetic circuit as claimed in claim 1, wherein the electric machinery is related to a coaxial 3-ring type electric machinery to engage coaxial operation by insertion of an inner ring, a mid ring, and an outer ring electric machinery structures including an inner ring electric machinery structure 21, a mid ring electric machinery structure 22, and an outer ring electric machinery structure 23.

6. The electric machinery provided with a PM magnetic pole sandwiched by a permeable polar face and a magnetic circuit as claimed in claim 1, wherein the electric machinery is related to a coaxial double layer type plate electric machinery comprised of two layers of electric machinery structure laminated to engage in coaxial operation includes an inner layer plate electric machinery structure 31 and an outer layer plate electric machinery structure 32.

7. The electric machinery provided with a PM magnetic pole sandwiched by a permeable polar face and a magnetic circuit as claimed in claim 1, wherein the electric machinery is related to a coaxial 3-layer type plate electric machinery comprised of an inner layer, a mid layer, and an outer layer electric machinery structures laminated to engage coaxial operation includes an inner layer plate electric machinery structure 41, a mid layer plate electric machinery structure 42, and an outer layer plate electric machinery structure 43.

8. The electric machinery provided with a PM magnetic pole sandwiched by a permeable polar face and a magnetic circuit as claimed in claim 1, wherein the electric machinery is related to a linearly coupled linear double layer type electric machinery comprised of two layers of linear electric machinery structures includes an inner layer linear electric machinery structure 51 and an outer layer linear electric machinery structure 52.

9. The electric machinery provided with a PM magnetic pole sandwiched by a permeable polar face and a magnetic circuit as claimed in claim 1, wherein a linearly coupled linear 3-layer type electric machinery comprised of a inner layer, a mid layer, and an outer layer linear electric machinery structures includes an inner layer linear electric machinery structure 61, a mid layer linear electric machinery structure 62, and an outer layer linear electric machinery structure 63.

10. The electric machinery provided with a PM magnetic pole sandwiched by a permeable polar face and a magnetic circuit as claimed in claim 1 is related to a cylinder electric machinery structure, wherein the outer layer electric machinery structure 12 to execute EME coupling with the inner layer electric machinery structure 11 has on its EME coupling aspect disposed the PM magnetic pole 103 sandwiched by the permeable polar face 111 and the magnetic circuit 102 from an individual magnetic pole thus to constitute a cylinder electric machinery provided with the PM magnetic pole 103 sandwiched by the permeable polar face 111 and the magnetic circuit 102 from the individual magnetic pole.

11. The electric machinery provided with a PM magnetic pole sandwiched by a permeable polar face and a magnetic circuit as claimed in claim 1 is related to a cylinder electric machinery structure, wherein the inner layer electric machinery structure 11 to execute EME coupling with the outer layer electric machinery structure 12 is provided on its EME coupling aspect the PM magnetic pole 103 sandwiched by the permeable polar face 111 and the magnetic circuit 102 from an individual magnetic pole thus to constitute a cylinder electric machinery provided with the PM magnetic pole 103 sandwiched by the permeable polar face 111 and the magnetic circuit 102 from the individual magnetic pole.

12. The electric machinery provided with a PM magnetic pole sandwiched by a permeable polar face and a magnetic circuit as claimed in claim 1 is related to a coaxial 3-ring type electric machinery structure, wherein the PM magnetic pole 103 sandwiched by a permeable polar face 111 and a magnetic circuit 102 from an individual magnetic pole is disposed on an EME coupling aspect of the outer ring electric machinery structure 23 in facing the mid ring electric machinery structure 22 to execute EME coupling with the mid ring electric machinery structure 22 thus to constitute a coaxial 3-ring type electric machinery provided with the PM magnetic pole 103 sandwiched by the permeable polar face 111 and the magnetic circuit 102 from the individual magnetic pole.

13. The electric machinery provided with a PM magnetic pole sandwiched by a permeable polar face and a magnetic circuit as claimed in claim 1 related to a coaxial 3-ring type electric machinery structure, wherein both of an EME coupling aspect of the outer ring electric machinery structure 23 to execute EMC coupling with the mid ring electric machinery structure 22 and an EME coupling aspect of the mid ring electric machinery structure 22 to execute EME coupling with the inner ring electric machinery structure 21 are respectively provided with the PM magnetic pole 103 sandwiched by a permeable polar face 111 and a magnetic circuit 102 from an individual magnetic pole thus to constitute a coaxial 3-ring type electric machinery provided with two PM magnetic poles 103 each being sandwiched by a permeable polar face 111 and a magnetic circuit 102 from an individual magnetic pole.

14. The electric machinery provided with a PM magnetic pole sandwiched by a permeable polar face and a magnetic circuit as claimed in claim 1 is related to a coaxial 3-ring type electric machinery structure, wherein the PM magnetic pole 103 sandwiched by a permeable polar face 111 and a magnetic circuit 102 from an individual magnetic pole is disposed on an EME coupling aspect of the mid ring electric machinery structure 22 in a direction facing the inner ring electric machinery structure 21 to execute EME coupling with the outer ring electric machinery structure 23 and the inner ring electric machinery structure 21 thus to constitute a coaxial 3-ring type electric machinery provided with a PM magnetic pole 103 sandwiched by a permeable polar face 111 and a magnetic circuit 102 from an individual magnetic pole.

15. The electric machinery provided with a PM magnetic pole sandwiched by a permeable polar face and a magnetic circuit as claimed in claim 1 related to a coaxial 3-ring type electric machinery structure, wherein the PM magnetic pole 103 sandwiched by the permeable polar face 111 and the magnetic circuit 102 from the individual magnetic pole is disposed on an EME coupling aspect of the inner ring electric machinery structure 21 in a direction facing the mid ring electric machinery structure 22 to execute EME coupling with the mid ring electric machinery structure 22 for both of the mid ring electric machinery structure 22 and the outer ring electric machinery structure 23 to interact with each other in executing EME so to jointly constitute a coaxial 3-ring type electric machinery provided with the PM magnetic pole 103 sandwiched by the permeable polar face 111 and the magnetic circuit 102 from the individual magnetic pole.

16. The electric machinery provided with a PM magnetic pole sandwiched by a permeable polar face and a magnetic circuit as claimed in claim 1 is related to a coaxial 3-ring type electric machinery structure, wherein both of an EME coupling aspect of the inner ring electric machinery structure 21 to execute EME coupling with the mid ring electric machinery structure 22 and an EME coupling aspect of the mid ring electric machinery structure 22 to execute EME coupling with the outer ring electric machinery structure 23 are respectively provided with the PM magnetic pole 103 sandwiched by the permeable polar face 111 and the magnetic circuit 102 from the individual magnetic pole for achieving EME interaction with the outer ring electric machinery structure 23 to jointly constitute a coaxial 3-ring type electric machinery provided with the PM magnetic pole 103 sandwiched by the permeable polar face 111 and the magnetic circuit 102 from the individual magnetic pole.

17. The electric machinery provided with a PM magnetic pole sandwiched by a permeable polar face and a magnetic circuit as claimed in claim 1 is related a coaxial 3-ring type electric machinery structure, wherein the PM magnetic pole 103 sandwiched by the permeable polar face 111 and the magnetic circuit 102 from the individual magnetic pole is provided on an EME coupling aspect of the mid ring electric machinery structure 22 in a direction facing the outer ring electric machinery structure 23 to execute EME coupling with the outer ring electric machinery structure 23 and the inner ring electric machinery structure 21 for the inner ring electric machinery structure 21 and the outer ring electric machinery structure 23 to execute EME interaction to jointly constitute a coaxial 3-ring type electric machinery provided with the PM magnetic pole 103 sandwiched by the permeable polar face 111 and the magnetic circuit 102 from the individual magnetic pole.

18. The electric machinery provided with a PM magnetic pole sandwiched by a permeable polar face and a magnetic circuit as claimed in claim 1 is related to a coaxial 3-ring type electric machinery structure, wherein both of the outer ring electric machinery structure 23 to execute EME coupling with the mid ring electric machinery structure 22 and the inner ring electric machinery structure 21 to execute EME coupling with the mid ring electric machinery structure 22 are respectively disposed with the PM magnetic pole 103 sandwiched by the permeable polar face 111 and the magnetic circuit 102 from the individual magnetic pole for jointly constituting with the mid ring electric machinery structure 22 a coaxial 3-ring type electric machinery provided with the PM magnetic pole 103 sandwiched by the permeable polar face 111 and the magnetic circuit 102 from the individual magnetic pole.

19. The electric machinery provided with a PM magnetic pole sandwiched by a permeable polar face and a magnetic circuit as claimed in claim 1 is related to a coaxial 3-ring type electric machinery structure, wherein two PM magnetic poles 103 each being sandwiched by the permeable polar face 111 and the magnetic circuit 102 from the individual magnetic pole are respectively disposed on two EME coupling aspects of the inner ring electric machinery structure 22 in both directions respectively facing the outer ring electric machinery structure 23 and the inner ring electric machinery structure 21 for both of the inner electric machinery structure 21 and the outer ring electric machinery structure 23 to execute EME interaction for jointly constituting a coaxial 3-ring type electric machinery provided with the PM magnetic pole 103 sandwiched by the permeable polar face 111 and the magnetic circuit 102 from the individual magnetic pole.

20. The electric machinery provided with a PM magnetic pole sandwiched by a permeable polar face and a magnetic circuit as claimed in claim 1 is related to a coaxial 3-ring type electric machinery structure, wherein the PM magnetic pole 103 to execute two-way coupling with the inner ring electric machinery structure 21 and the outer ring electric machinery structure 23 is provided to the mid ring electric machinery structure 22 to execute EME coupling with the inner ring electric machinery structure 21 and the outer ring electric machinery structure 23 to constitute a magnetic pole; and both polar faces on both ends of the PM magnetic pole 103 are each disposed with a permeable polar face 111 thus to constitute a coaxial 3-ring type electric machinery respectively provided at both ends of the PM magnetic pole the permeable polar face 111.

21. The electric machinery provided with a PM magnetic pole sandwiched by a permeable polar face and a magnetic circuit as claimed in claim 1 is related to a double layer type plate electric machinery structure, wherein the PM magnetic pole 103 sandwiched by the permeable polar face 111 and the magnetic circuit 102 from the individual magnetic pole is disposed on an EME coupling aspect of the inner layer plate electric machinery structure 31 to execute EME coupling interaction with the outer layer plate electric machinery structure 32 for jointly constituting a double layer type plate electric machinery provided with the PM magnetic pole 103 sandwiched by the permeable polar face 111 and the magnetic circuit 102 from the individual magnetic pole.

22. The electric machinery provided with a PM magnetic pole sandwiched by a permeable polar face and a magnetic circuit as claimed in claim 1 is related to a coaxial 3-layer type plate electric machinery structure, wherein the PM magnetic pole 103 sandwiched by the permeable polar face 111 and the magnetic circuit 102 from the individual magnetic pole disposed on an EME coupling aspect of an inner layer plate electric machinery structure 41 for both of the mid layer plate electric machinery structure 42 and the outer layer plate electric machinery structure 43 to execute EME interaction for jointly constituting a 3-layer type plate electric machinery provided with the PM magnetic pole 103 sandwiched by the permeable polar face 111 and the magnetic circuit 102 from the individual magnetic pole.

23. The electric machinery provided with a PM magnetic pole sandwiched by a permeable polar face and a magnetic circuit as claimed in claim 1 is related to a coaxial 3-layer type plate electric machinery structure, wherein both of an EME coupling aspect of the inner layer plate electric machinery structure 41 in facing the mid layer plate electric machinery structure 42, and an EME coupling aspect of the mid layer plate electric machinery structure 42 in facing the outer layer plate electric machinery structure 43 are respectively disposed with the PM magnetic pole 103 sandwiched by the permeable polar face 111 and the magnetic circuit 102 from the individual magnetic pole for jointly constituting with the outer layer plate electric machinery structure 43 a 3-layer type plate electric machinery provided with the PM magnetic pole 103 sandwiched by the permeable polar face 111 and the magnetic circuit 102 from the individual magnetic pole.

24. The electric machinery provided with a PM magnetic pole sandwiched by a permeable polar face and a magnetic circuit as claimed in claim 1 is related to a coaxial 3-layer type plate electric machinery structure, wherein the PM magnetic pole 103 sandwiched by the permeable polar face 111 and the magnetic circuit 102 from the individual magnetic pole is disposed to the mid layer plate electric machinery structure 42 to execute EME coupling with the inner layer plate electric machinery structure 41 and the outer layer plate electric machinery structure 43 disposed on both sides of the mid layer plate electric machinery structure 42 in a direction facing the inner layer plate electric machinery structure 41 to execute EME interaction with the inner layer plate electric machinery structure 41 and the outer layer plate electric machinery structure 43, thus to jointly constitute a 3-layer type plate electric machinery provided with the PM magnetic pole 103 sandwiched by the permeable polar face 111 and the magnetic circuit 102 from the individual magnetic pole.

25. The electric machinery provided with a PM magnetic pole sandwiched by a permeable polar face and a magnetic circuit as claimed in claim 1 is related to a coaxial 3-layer type plate electric machinery structure, wherein both of an EME coupling aspect of the inner layer plate electric machinery structure 41 and an EME coupling aspect of the outer layer plate electric machinery structure 43 respectively to execute EME coupling with the mid layer plate electric machinery structure 42 are each disposed with the PM magnetic pole 103 sandwiched by the permeable polar face 111 and the magnetic circuit 102 from the individual magnetic pole to execute EME interaction with the mid layer electric machinery structure 42 thus to jointly constitute a 3-layer type plate electric machinery provided with the PM magnetic pole 103 sandwiched by the permeable polar face 111 and the magnetic circuit 102 from the individual magnetic pole.

26. The electric machinery provided with a PM magnetic pole sandwiched by a permeable polar face and a magnetic circuit as claimed in claim 1 is related to a coaxial 3-layer type plate electric machinery structure, wherein two EME coupling aspects on both sides of the mid layer plate electric machinery structure 42 to execute EME coupling with an inner layer plate electric machinery structure 41 and the outer layer plate electric machinery structure 43 provided on both sides of the mid layer plate electric machinery structure 42 are respectively disposed with the PM magnetic pole 103 sandwiched by the permeable polar face 111 and the magnetic circuit 102 from the individual magnetic pole for executing EME interaction with the inner layer plate electric machinery structure 41 and the outer layer plate electric machinery structure 43 thus to jointly constitute a 3-layer type plate electric machinery provided with the PM magnetic pole 103 sandwiched by the permeable polar face 111 and the magnetic circuit 102 from the individual magnetic pole.

27. The electric machinery provided with a PM magnetic pole sandwiched by a permeable polar face and a magnetic circuit as claimed in claim 1 is related to a coaxial 3-layer type plate electric machinery structure, wherein the PM magnetic pole 103 is disposed to the mid layer plate electric machinery structure 42 to execute EME coupling with the inner layer plate electric machinery structure 41 and the outer layer plate electric machinery structure 43 provided on both sides of the mid layer plate electric machinery structure 42 thus to constitute magnetic pole; two permeable polar faces 111 are each disposed on both polar faces at both ends of the PM magnetic pole 103 to execute EME interaction with the inner layer plate electric machinery structure 41 and the outer layer plate electric machinery structure 43 for jointly constituting a coaxial 3-layer type plate electric machinery provided with two permeable polar faces 111 on each of two polar faces disposed on both ends of the PM magnetic pole.

28. The electric machinery provided with a PM magnetic pole sandwiched by a permeable polar face and a magnetic circuit as claimed in claim 1 is related to a linear double layer type electric machinery structure, wherein the PM magnetic pole 103 sandwiched by the permeable polar face 111 and the magnetic circuit 102 from the individual magnetic pole is disposed on an EME coupling aspect of the inner layer linear electric machinery structure 51 to execute EME interaction with the outer layer linear electric machinery structure 52 thus to jointly constitute a double layer type electric machinery provided with the PM magnetic pole 103 sandwiched by the permeable polar face 111 and the magnetic circuit 102 from the individual magnetic pole.

29. The electric machinery provided with a PM magnetic pole sandwiched by a permeable polar face and a magnetic circuit as claimed in claim 1 is related to a linear 3-layer type electric machinery structure, wherein the PM magnetic pole 103 sandwiched by the permeable polar face 111 and the magnetic circuit 102 from the individual magnetic pole is disposed to the inner layer linear electric machinery structure 61 to execute EME coupling with the mid layer linear electric machinery structure 62 for executing EME interaction with the inner layer linear electric machinery structure 61 and the outer layer linear electric machinery structure 63 thus to jointly constitute a linear 3-layer type electric machinery provided with the PM magnetic pole 103 sandwiched by the permeable polar face 111 and the magnetic circuit 102 from the individual magnetic pole.

30. The electric machinery provided with a PM magnetic pole sandwiched by a permeable polar face and a magnetic circuit as claimed in claim 1 is related to a linear 3-layer type electric machinery structure, wherein both of an EME coupling aspect of the mid layer linear electric machinery structure 62 to execute EME coupling with the outer layer linear electric machinery structure 63 and an EME coupling aspect of the inner layer linear electric machinery structure 61 to execute EME coupling with the mid layer linear electric machinery structure 62 are respectively disposed with the PM magnetic pole 103 sandwiched by the permeable polar face 111 and the magnetic circuit 102 from the individual magnetic pole for executing EME interaction with the outer layer linear electric machinery structure 63, thus to jointly constitute a linear 3-layer type electric machinery provided with the PM magnetic pole 103 sandwiched by the permeable polar face 111 and the magnetic circuit 102 from the individual magnetic pole.

31. The electric machinery provided with a PM magnetic pole sandwiched by a permeable polar face and a magnetic circuit as claimed in claim 1 is related to a linear 3-layer type electric machinery structure, wherein the PM magnetic pole 103 sandwiched by the permeable polar face 111 and the magnetic circuit 102 from the individual magnetic pole is disposed to the mid layer linear electric machinery structure 62 in a direction facing the inner layer linear electric machinery structure 61 for executing EME coupling with the outer layer linear electric machinery structure 63 and the inner layer linear electric machinery structure 61 so to execute EME interaction with the inner layer linear electric machinery structure 61 and the outer layer linear electric machinery structure 63, thus to jointly constitute a linear 3-layer type electric machinery provided with the PM magnetic pole 103 sandwiched by the permeable polar face 111 and the magnetic circuit 102 from the individual magnetic pole.

32. The electric machinery provided with a PM magnetic pole sandwiched by a permeable polar face and a magnetic circuit as claimed in claim 1 is related to a linear 3-layer type electric machinery structure, wherein an EME coupling aspect of the outer layer linear electric machinery structure 63 to execute EME coupling with the mid layer linear electric machinery structure 62, and an EME coupling aspect of the inner layer linear electric machinery structure 61 are respectively disposed with the PM magnetic pole 103 sandwiched by the permeable polar face 111 and the magnetic circuit 102 from the individual magnetic pole for executing EME interaction with the mid layer linear electric machinery structure 62, thus to joint constitute a linear 3-layer type electric machinery provided with the PM magnetic pole 103 sandwiched by the permeable polar face 111 and the magnetic circuit 102 from the individual magnetic pole.

33. The electric machinery provided with a PM magnetic pole sandwiched by a permeable polar face and a magnetic circuit as claimed in claim 1 is related to a linear 3-layer type electric machinery structure, wherein two PM magnetic poles 103 each being sandwiched by the permeable polar face 111 and the magnetic circuit 102 from the individual magnetic pole are respectively disposed on two EME coupling aspects disposed to both sides of the mid layer linear electric machinery structure 62 to execute EME coupling with the outer layer linear electric machinery structure 63 and the inner layer linear electric machinery structure 61 for executing EME interaction with the inner layer linear electric machinery structure 61 and the outer layer linear electric machinery structure 63 thus to jointly constitute a linear 3-layer type electric machinery provided with the PM magnetic pole 103 sandwiched by the permeable polar face 111 and the magnetic circuit 102 from the individual magnetic pole.

34. The electric machinery provided with a PM magnetic pole sandwiched by a permeable polar face and a magnetic circuit as claimed in claim 1 is related to a linear 3-layer type electric machinery structure, wherein a PM magnetic pole 103 is disposed to the mid layer linear electric machinery structure 62 to constitute a magnetic pole for executing EME coupling with the outer layer linear electric machinery structure 63 and the inner layer linear electric machinery structure 61; and a permeable polar face 111 is each disposed on both polar faces at both ends of the PM magnetic pole 103 for executing EME interaction with the inner layer linear electric machinery structure 61 and the outer layer linear electric machinery structure 63, thus to jointly constitute a linear 3-layer type electric machinery provided with two permeable solar faces 111 each disposed on two polar faces on both ends of the PM magnetic pole 103.

35. The electric machinery provided with a PM magnetic pole sandwiched by a permeable polar face and a magnetic circuit as claimed in claims 1, wherein the quantity of the magnetic pole disposed on the EME coupling aspect of each electric machinery structure is selected to be the same or different as applicable.

36. The electric machinery provided with a PM magnetic pole sandwiched by a permeable polar face and a magnetic circuit as claimed in claim 1, wherein the operation types of two electric machinery components interacting with each other by means of EME of the electric machinery disposed with a PM magnetic pole sandwiched by a permeable polar face and a magnetic circuit in case of the cylinder electric machinery, or the double layer type plate electric machinery, or the double layer type linear electric machinery for producing function of a generator, a motor, an EME vortex coupling transmission, or EME vortex braking function include:
(1) Either electric machinery structural component serves as a static portion while another electric machinery structural component serves as a mobile portion; or
(2) Both electric machinery structural components function as the mobile portions.

37. The electric machinery provided with a PM magnetic pole sandwiched by a permeable polar face and a magnetic circuit as claimed in claim 1, wherein the electric machinery provided with a PM magnetic pole sandwiched by a permeable polar face and a magnetic circuit from an individual magnetic pole, e.g., the coaxial 3-ring type electric machinery, the coaxial 3-layer type plate electric machinery, or the linear 3-layer type electric machinery, those three interacting electric machinery structural components for producing function of a generator, a motor, an EME vortex coupling transmission, or EME vortex braking function provide the following composition functions:
(1) One EM structural component serves as a static portion while the other two EM structural components function as two mobile portions; or
(2) Two EM structural components serve as two static portions while the third EM structural component serves as a mobile portion; or
(3) All three EM structural components each serves as a mobile portion.

38. The electric machinery provided with a PM magnetic pole sandwiched by a permeable polar face and a magnetic circuit as claimed in claims 1, wherein selection and layout of electric machinery structure and windings for the electric machinery structural component of the PM magnetic pole sandwiched by the permeable polar face and a magnetic circuit from the individual magnetic pole and other electric machinery structural components executing EME coupling interaction are determined according to the property of the assembly of the entire electric machinery, nature of the power inputted, control function, control mode, and output performance requirements.

39. The electric machinery provided with a PM magnetic pole sandwiched by a permeable polar face and a magnetic circuit as claimed in claims 1, wherein the properties of the assembly of the electric machinery provided with a PM magnetic pole sandwiched by a permeable polar face and a magnetic circuit including those for operating in DC or AC revolution or linear electric machinery are comprised of commutator brush, brushless, ring-brush, synchronous, asynchronous, internal revolving, external revolving, double-acting, multi-layer, multi-ring, linear, DC brushless, or inverter electric machinery, or an electric machinery functioning as a generator or as a motor, coupling transmission device, as an EME vortex coupling transmission device, or an EME vortex braking device.
